(19) United States
(12) Patent Application Publication
(10) Pub. No.: US 2025/0119467 A1
(43) Pub. Date: Apr. 10, 2025

(54) METHOD AND SYSTEM FOR USING A STREAMING STORAGE SYSTEM FOR PIPELINING DATA-INTENSIVE SERVERLESS FUNCTIONS

(71) Applicant: Dell Products L.P., Round Rock, TX (US)

(72) Inventors: Raúl Gracia-Tinedo, Barcelona (ES); Flavio Paiva Junqueira, Barcelona (ES); James Geonho Kim, Buford, GA (US)

(21) Appl. No.: 18/482,682

(22) Filed: Oct. 6, 2023

(51) Int. Cl. H04L 67/1097; G06F 3/06

(52) U.S. Cl. CPC H04L 67/1097; G06F 3/0614; G06F 3/0629

(57) ABSTRACT

A method for managing a serverless function (SF) pipeline includes: reading, by a first function, a dataset from a data input; writing, by the first function, a result to a segment of a data stream; reading, by a second function, the result; writing, by the second function, the result to a transaction; starting, by the second function and after a checkpoint is generated, to process the transaction; making, by an orchestrator and a determination, that the second function is failed; re-initiating, by the orchestrator and based on the determination, the second function, in which, upon re-initiated, the second function resumes processing the transaction from the checkpoint; generating, by the second function and upon completion of the processing of the transaction, a data output; and storing, by the second SF, the data output to a tier-2 storage.

### BACKGROUND

Streaming applications are applications that deal with a large amount of data arriving continuously. In processing streaming application data, the data can arrive late, arrive out of order, and the processing can undergo failure conditions. It can be appreciated that tools designed for previous generations of big data applications may not be ideally suited to process and store streaming application data.

### BRIEF DESCRIPTION OF DRAWINGS

Certain embodiments of the invention will be described with reference to the accompanying drawings. However, the accompanying drawings illustrate only certain aspects or implementations of the invention by way of example, and are not meant to limit the scope of the claims.

FIG. 1.1 shows a diagram of a system in accordance with one or more embodiments of the invention.

FIG. 1.2 shows a diagram of a streaming storage system in accordance with one or more embodiments of the invention.

FIG. 2.1 shows how the streaming storage system is utilized as a storage substrate for data-intensive serverless functions and data-intensive serverless function pipelining in accordance with one or more embodiments of the invention.

FIG. 2.2 shows how using a data stream instead of object storage improves a compute parallelism and overall compute time in data-intensive serverless function pipelining in accordance with one or more embodiments of the invention.

FIG. 2.3 shows how routing keys and the exclusive assignment of segments to reader components are used to generate a map-reduce-like computation framework for Function-as-a-Service (FaaS) pipelines in accordance with one or more embodiments of the invention.

FIG. 3 shows how stream transactions and checkpoints are utilized to achieve exactly-once semantics in data-intensive serverless function pipelines in accordance with one or more embodiments of the invention.

FIGS. 4.1 and 4.2 show a method for managing a serverless function pipeline in accordance with one or more embodiments of the invention.

FIG. 5 shows a diagram of a computing device in accordance with one or more embodiments of the invention.

### DETAILED DESCRIPTION

Specific embodiments of the invention will now be described in detail with reference to the accompanying figures. In the following detailed description of the embodiments of the invention, numerous specific details are set forth in order to provide a more thorough understanding of one or more embodiments of the invention. However, it will be apparent to one of ordinary skill in the art that the one or more embodiments of the invention may be practiced without these specific details. In other instances, well-known features have not been described in detail to avoid unnecessarily complicating the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In recent years, serverless computing (e.g., the FaaS paradigm) is becoming increasingly popular for users/administrators to execute computations on large datasets (e.g., OpenWhisk, AWS Lambda, etc.). In most cases, the main difference between conventional dataflow analytics and serverless computing is related to the required resource management, in which executing dataflow analytics (e.g., via systems such as Apache Flink, Apache Spark, etc.) requires users to decide about correct-sizing the underlying cluster that will be running analytics jobs based on expected workload. Conversely, in serverless computing, users may just concentrate on the function (that needs to be executed) and the target dataset, while the remaining elements of the computing process may become uncertain to the infrastructure (e.g., the FaaS platform). At the background, the FaaS platform may take care of instantiating the correct number of functions according to the partitioning of an input dataset. This may also translate into a simpler programming paradigm (including, for example, simple application programming interfaces (APIs), an imperative code style, etc.) that has a high potential to increase the adoption of cloud computing by non-advanced users.

However, the simplicity of the FaaS paradigm (that allows orchestration of serverless functions) may also yield inefficiencies when it comes to orchestrating multiple functions in data-intensive use cases. More specifically, the main approach to orchestrate two serverless functions is a sequential approach, for example: (i) Function A may read input data (e.g., an event, a data object, etc.) and perform some processing on the input data, and then (ii) Function A may store an intermediate result (normally in object storage) and Function B may start reading Function A's result (from the object storage) to execute its own processing. Further, as of today, most vendors enable users to pass state and/or intermediate results across functions via parameter objects that are limited in size. If the size is not enough, users normally use an external service (e.g., the object storage) to store the intermediate results (of one or more functions) and make them available for a next group of functions to consume.

As indicated, the sequential approach for pipelining serverless functions is not ideal for several reasons: (a) there is no direct and efficient communication channel across serverless functions to transfer large data objects (e.g., intermediate results may need to be stored and read from object storage, which yields additional per-request costs), (b) in general, a second function that feeds on the input of a first function may need to wait for the first function to complete and write its “intermediate” result to object storage to start its own processing (e.g., this means that the sequential approach has no pipelining properties, which may induce additional latency overhead), (c) there is no built-in mechanism to guarantee exactly-once semantics in a data-intensive workflow consisting of several pipelined serverless functions (e.g., this means that users may need to implement ad-hoc logic to infer whether some data has been already processed or not after recovering from a failure), and (d) in some cases, requests to services (e.g., object storages like AWS S3) may be billed separately.

For at least the reasons discussed above and without requiring resource (e.g., time, engineering, etc.) intensive efforts, a fundamentally different approach is needed (e.g., an approach that exploits streaming storage services (e.g., Dell Pravega) as a storage substrate for data-intensive serverless functions and serverless function pipelining, an approach of exploiting streaming storage services for transferring partial results in data-intensive FaaS pipelines (which is different from the common usage of messaging systems), etc.). The Pravega based approach is an effective and user-friendly approach for, at least: (i) leveraging efficient serverless function pipelining (e.g., where functions may be feed on results of other functions as soon as the first byte (of a result) is available, rather than waiting for a function to complete (its job) to ingest its output), (ii) processing large data objects (e.g., audio data objects, video data objects, image data objects, etc.); (iii) leveraging unique “elasticity” functionality of Pravega that may adapt a data stream's parallelism to the number of serverless functions to be executed; (iv) leveraging unique “stream transaction” and “checkpoint” functionalities of Pravega in data streams, for example, to implement exactly-once semantics in data-intensive FaaS pipelines (e.g., pipelines that may execute on cloud or on-premise FaaS platforms where functions may access external services/systems, such as streaming storage systems (e.g., Pravega) and object storages (e.g., AWS S3, Dell ECS, etc.)).

Embodiments of the invention relate to using a streaming storage system for pipelining data-intensive serverless functions. As a result of the processes/functionalities discussed below, one or more embodiments disclosed herein advantageously ensure that: (i) serverless functions are allowed to transfer data (e.g., results) to one another in a “stream” manner (rather than using objects) for reducing compute times and increasing performance; (ii) a streaming storage system (e.g., Pravega) is used as a substrate for storing and transferring intermediate results across serverless functions (e.g., when orchestrating multiple serverless functions in a pipeline, intermediate results may be stored in streams rather than data objects); (iii) streams are used (instead of objects) for transferring results across serverless functions to lower latency (and compute times) of serverless function pipelines (e.g., in this manner, functions do not need to wait for results from previous functions to be completed and stored in object storage, as intermediate results can be processed in a streaming fashion); (iv) with the use of data streams in FaaS pipelines, a novel map-reduce-like computation substrate is introduced for serverless functions (said another way, by exploiting the characteristics of Pravega data streams (e.g., routing keys, exclusive reader access to segments in a reader group, reader group exclusive segment assignments, etc.), stream map-reduce-like form of computations for serverless functions are enabled/built on top of system guarantees of Pravega); (v) elastic data streams (e.g., which is a unique feature of Pravega data streams, where Apache Kafka or Pulsar cannot dynamically repartition a topic without user/admin intervention) are used for transferring results across serverless functions (e.g., which is useful if a given data stream is repartitioned (dynamically) across stages of serverless functions based on the parallelism of the processing pipeline and/or the number of functions varying across compute stages); (vi) in order to achieve exactly-once semantics (which is a major issue in FaaS pipelines) in serverless function pipelines, a combination of stream transactions and reader group checkpoints (available in Pravega) are used (e.g., this helps to build exactly-once guarantees in data-intensive serverless function pipelines, rather than leaving this problem to be solved in an ad-hoc manner by users); (vii) the presented approach can be exploited in multiple FaaS scenarios (either public or on-premise, if functions can access external services) to provide a better user/customer experience and broad applicability (which is not possible today); (viii) orchestration of serverless functions are improved (e.g., state management and intermediate result transfer across data-intensive functions are improved); (ix) efficient pipelining of data-intensive serverless functions (e.g., functions that deal with moderate to large object sizes (e.g., video files, audio files, large image files, large text files, etc.)) is realized while exploiting streaming storage systems to transfer intermediate results across groups of serverless functions (in this manner, a workflow of multiple functions may work in parallel for processing data byte-by-byte, instead of waiting for the whole intermediate result from previous functions); and/or (x) administrators not need to invest most of their time and engineering efforts to overcome the aforementioned issues for a better product management and development.

The following describes various embodiments of the invention.

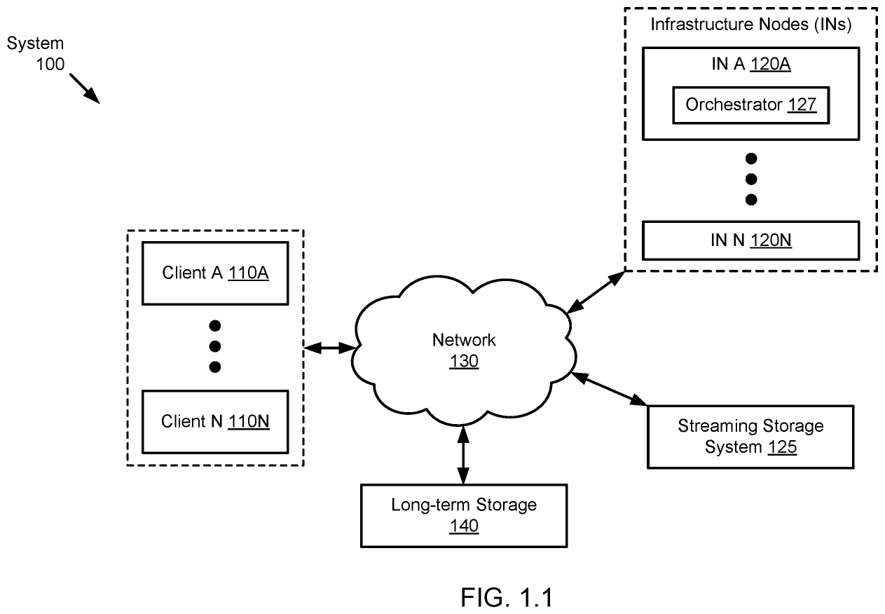

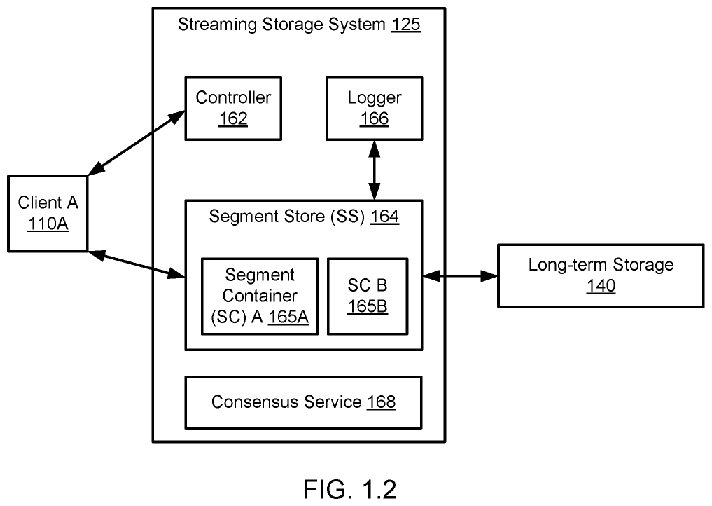

FIG. 1.1 shows a diagram of a system (100) in accordance with one or more embodiments of the invention. The system (100) includes any number of clients (e.g., Client A (110A), Client B (110B), etc.), any number of infrastructure nodes (e.g., Infrastructure Node A (120A), Infrastructure Node B (120B), etc.), a long-term storage (140) (e.g., a tier-2 storage), a streaming storage system (125), and a network (130). The system (100) may facilitate the management of “stream” data from any number of sources (e.g., 110A, 110B, etc.). The system (100) may include additional, fewer, and/or different components without departing from the scope of the invention. Each component may be operably connected to any of the other components via any combination of wired and/or wireless connections. Each component illustrated in FIG. 1.1 is discussed below.

In one or more embodiments, the clients (e.g., 110A, 110B, etc.), the infrastructure nodes (e.g., 120A, 120B, etc.), the long-term storage (140), the streaming storage system (125), and the network (130) may be (or may include) physical or logical devices, as discussed below. While FIG. 1.1 shows a specific configuration of the system (100), other configurations may be used without departing from the scope of the invention. For example, although the clients (e.g., 110A, 110B, etc.) and the infrastructure node (120) are shown to be operatively connected through a communication network (e.g., 130), the clients (e.g., 110A, 110B, etc.) and the infrastructure nodes (e.g., 120A, 120B, etc.) may be directly connected (e.g., without an intervening communication network).

Further, functioning of the clients (e.g., 110A, 110B, etc.) and the infrastructure nodes (e.g., 120A, 120B, etc.) is not dependent upon the functioning and/or existence of the other components (e.g., devices) in the system (100). Rather, the clients and the infrastructure nodes may function independently and perform operations locally that do not require communication with other components. Accordingly, embodiments disclosed herein should not be limited to the configuration of components shown in FIG. 1.1.

As used herein, “communication” may refer to simple data passing, or may refer to two or more components coordinating a job. As used herein, the term “data” is intended to be broad in scope. In this manner, that term embraces, for example (but not limited to): a data stream (or stream data) (including multiple events, each of which is associated with a routing key) that are continuously produced by streaming data sources (e.g., writers, clients, etc.), data chunks, data blocks, atomic data, emails, objects of any type, files of any type (e.g., media files, spreadsheet files, database files, etc.), contacts, directories, sub-directories, volumes, etc.

In one or more embodiments, although terms such as “document”, “file”, “segment”, “block”, or “object” may be used by way of example, the principles of the present disclosure are not limited to any particular form of representing and storing data or other information. Rather, such principles are equally applicable to any object capable of representing information.

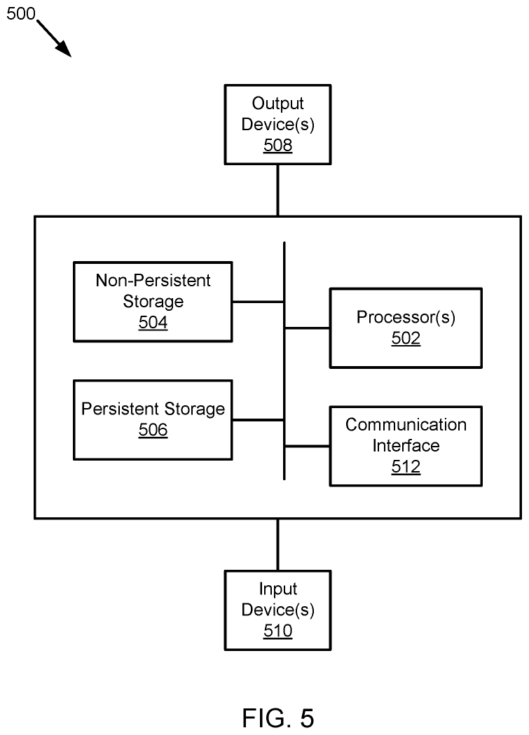

In one or more embodiments, the system (100) may be a distributed system (e.g., a data processing environment for processing streaming application data) and may deliver at least computing power (e.g., real-time network monitoring, server virtualization, etc.), storage capacity (e.g., data backup), and data protection (e.g., software-defined data protection, disaster recovery, etc.) as a service to users of clients (e.g., 110A, 110B, etc.). For example, the system (100) may be configured to organize unbounded, continuously generated data into a stream (described below in reference to FIG. 1.2) that may be auto-scaled based on individual segment loading. The system (100) may also represent a comprehensive middleware layer executing on computing devices (e.g., 500, FIG. 5) that supports application and storage environments.

In one or more embodiments, the system (100) may support one or more virtual machine (VM) environments, and may map capacity requirements (e.g., computational load, storage access, etc.) of VMs and supported applications to available resources (e.g., processing resources, storage resources, etc.) managed by the environments. Further, the system (100) may be configured for workload placement collaboration and computing resource (e.g., processing, storage/memory, virtualization, networking, etc.) exchange.

To provide computer-implemented services to the users, the system (100) may perform some computations (e.g., data collection, distributed processing of collected data, etc.) locally (e.g., at the users' site using one or more clients (e.g., 110A, 110B, etc.)) and other computations remotely (e.g., away from the users' site using the infrastructure nodes (e.g., 120A, 120B, etc.)) from the users. By doing so, the users may utilize different computing devices that have different quantities of computing resources (e.g., processing cycles, memory, storage, etc.) while still being afforded a consistent user experience. For example, by performing some computations remotely, the system (100) (i) may maintain the consistent user experience provided by different computing devices even when the different computing devices possess different quantities of computing resources, and (ii) may process data more efficiently in a distributed manner by avoiding the overhead associated with data distribution and/or command and control via separate connections.

As used herein, “computing” refers to any operations that may be performed by a computer, including (but not limited to): computation, data storage, data retrieval, communications, etc. Further, as used herein, a “computing device” refers to any device in which a computing operation may be carried out. A computing device may be, for example (but not limited to): a compute component, a storage component, a network device, a telecommunications component, etc.

As used herein, a “resource” refers to any program, application, document, file, asset, executable program file, desktop environment, computing environment, or other resource made available to, for example, a user of a client (described below). The resource may be delivered to the client via, for example (but not limited to): conventional installation, a method for streaming, a VM executing on a remote computing device, execution from a removable storage device connected to the client (such as universal serial bus (USB) device), etc.

In one or more embodiments, a client (e.g., 110A, 110B, etc.) may include functionality to, e.g.: (i) capture sensory input (e.g., sensor data) in the form of text, audio, video, touch or motion, (ii) collect massive amounts of data at the edge of an Internet of things (IoT) network (where, the collected data may be grouped as: (a) data that needs no further action and does not need to be stored, (b) data that should be retained for later analysis and/or record keeping, and (c) data that requires an immediate action/response), (iii) provide to other entities (e.g., the infrastructure nodes (e.g., 120A, 120B, etc.)), store, or otherwise utilize captured sensor data (and/or any other type and/or quantity of data), and/or (iv) provide surveillance services (e.g., determining object-level information, performing face recognition, etc.) for scenes (e.g., a physical region of space). One of ordinary skill will appreciate that the client may perform other functionalities without departing from the scope of the invention.

In one or more embodiments, clients (e.g., 110A, 110B, etc.) may be geographically distributed clients (e.g., user devices, front-end devices, etc.) and may have relatively restricted hardware and/or software resources when compared to the infrastructure nodes (e.g., 120A, 120B, etc.). As being, for example, a sensing device, each of the clients may be adapted to provide monitoring services. For example, a client may monitor the state of a scene (e.g., objects disposed in a scene). The monitoring may be performed by obtaining sensor data from sensors that are adapted to obtain information regarding the scene, in which a client may include and/or be operatively coupled to one or more sensors (e.g., a physical device adapted to obtain information regarding one or more scenes).

In one or more embodiments, the sensor data may be any quantity and types of measurements (e.g., of a scene's properties, of an environment's properties, etc.) over any period(s) of time and/or at any points-in-time (e.g., any type of information obtained from one or more sensors, in which different portions of the sensor data may be associated with different periods of time (when the corresponding portions of sensor data were obtained)). The sensor data may be obtained using one or more sensors. The sensor may be, for example (but not limited to): a visual sensor (e.g., a camera adapted to obtain optical information (e.g., a pattern of light scattered off of the scene) regarding a scene), an audio sensor (e.g., a microphone adapted to obtain auditory information (e.g., a pattern of sound from the scene) regarding a scene), an electromagnetic radiation sensor (e.g., an infrared sensor), a chemical detection sensor, a temperature sensor, a humidity sensor, a count sensor, a distance sensor, a global positioning system sensor, a biological sensor, a differential pressure sensor, a corrosion sensor, etc.

In one or more embodiments, sensor data may be implemented as, for example, a list. Each entry of the list may include information representative of, for example, (i) periods of time and/or points-in-time associated with when a portion of sensor data included in the entry was obtained and/or (ii) the portion of sensor data. The sensor data may have different organizational structures without departing from the scope of the invention. For example, the sensor data may be implemented as a tree, a table, a linked list, etc.

In one or more embodiments, clients (e.g., 110A, 110B, etc.) may be physical or logical computing devices configured for hosting one or more workloads, or for providing a computing environment whereon workloads may be implemented. The clients may provide computing environments that are configured for, at least: (i) workload placement collaboration, (ii) computing resource (e.g., processing, storage/memory, virtualization, networking, etc.) exchange, and (iii) protecting workloads (including their applications and application data) of any size and scale (based on, for example, one or more service level agreements (SLAs) configured by users of the clients). The clients may correspond to computing devices that one or more users use to interact with one or more components of the system (100).

In one or more embodiments, a client (e.g., 110A, 110B, etc.) may include any number of applications (and/or content accessible through the applications) that provide computer-implemented application services to a user. Applications may be designed and configured to perform one or more functions instantiated by a user of the client. In order to provide application services, each application may host similar or different components. The components may be, for example (but not limited to): instances of databases, instances of email servers, etc. Applications may be executed on one or more clients as instances of the application.

Applications may vary in different embodiments, but in certain embodiments, applications may be custom developed or commercial (e.g., off-the-shelf) applications that a user desires to execute in a client (e.g., 110A, 110B, etc.). In one or more embodiments, applications may be logical entities executed using computing resources of a client. For example, applications may be implemented as computer instructions stored on persistent storage of the client that when executed by the processor(s) of the client cause the client to provide the functionality of the applications described throughout the application.

In one or more embodiments, while performing, for example, one or more operations requested by a user, applications installed on a client (e.g., 110A, 110B, etc.) may include functionality to request and use physical and logical resources of the client. Applications may also include functionality to use data stored in storage/memory resources of the client. The applications may perform other types of functionalities not listed above without departing from the scope of the invention. While providing application services to a user, applications may store data that may be relevant to the user in storage/memory resources of the client.

In one or more embodiments, to provide services to the users, clients (e.g., 110A, 110B, etc.) may utilize, rely on, or otherwise cooperate with the infrastructure nodes (e.g., 120A, 120B, etc.). For example, clients may issue requests to an infrastructure node (e.g., 120A) to receive responses and interact with various components of the infrastructure node. Clients may also request data from and/or send data to the infrastructure node (for example, clients may transmit information to the infrastructure node that allows the infrastructure node to perform computations, the results of which are used by the clients to provide services to the users). As yet another example, clients may utilize application services provided by an infrastructure node (e.g., 120A). When clients interact with the infrastructure node, data that is relevant to the clients may be stored (temporarily or permanently) in the infrastructure node.

In one or more embodiments, a client (e.g., 110A, 110B, etc.) may be capable of, e.g.: (i) collecting users' inputs, (ii) correlating collected users' inputs to the computer-implemented services to be provided to the users, (iii) communicating with the infrastructure nodes (e.g., 120A, 120B, etc.) that perform computations necessary to provide the computer-implemented services, (iv) using the computations performed by the infrastructure nodes to provide the computer-implemented services in a manner that appears (to the users) to be performed locally to the users, and/or (v) communicating with any virtual desktop (VD) in a virtual desktop infrastructure (VDI) environment (or a virtualized architecture) provided by an infrastructure node (using any known protocol in the art), for example, to exchange remote desktop traffic or any other regular protocol traffic (so that, once authenticated, users may remotely access independent VDs).

In one or more embodiment, a VDI environment (or a virtualized architecture) may be employed for numerous reasons, for example (but not limited to): to manage resource (or computing resource) utilization, to provide cost-effective scalability across multiple servers, to provide a workload portability across multiple servers, to streamline an application development by certifying to a common virtual interface rather than multiple implementations of physical hardware, to encapsulate complex configurations into a file that is easily replicated and provisioned, etc.

As described above, clients (e.g., 110A, 110B, etc.) may provide computer-implemented services to users (and/or other computing devices). Clients may provide any number and any type of computer-implemented services. To provide computer-implemented services, each client may include a collection of physical components (e.g., processing resources, storage/memory resources, networking resources, etc.) configured to perform operations of the client and/or otherwise execute a collection of logical components (e.g., virtualization resources) of the client.

In one or more embodiments, a processing resource (not shown) may refer to a measurable quantity of a processing-relevant resource type, which can be requested, allocated, and consumed. A processing-relevant resource type may encompass a physical device (i.e., hardware), a logical intelligence (i.e., software), or a combination thereof, which may provide processing or computing functionality and/or services. Examples of a processing-relevant resource type may include (but not limited to): a central processing unit (CPU), a graphics processing unit (GPU), a data processing unit (DPU), a computation acceleration resource, an application-specific integrated circuit (ASIC), a digital signal processor for facilitating high speed communication, etc.

In one or more embodiments, a storage or memory resource (not shown) may refer to a measurable quantity of a storage/memory-relevant resource type, which can be requested, allocated, and consumed (for example, to store sensor data and provide previously stored data). A storage/memory-relevant resource type may encompass a physical device, a logical intelligence, or a combination thereof, which may provide temporary or permanent data storage functionality and/or services. Examples of a storage/memory-relevant resource type may be (but not limited to): a hard disk drive (HDD), a solid-state drive (SSD), random access memory (RAM), Flash memory, a tape drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), persistent memory (PMEM), virtualized storage, virtualized memory, etc.

In one or more embodiments, while the clients (e.g., 110A, 110B, etc.) provide computer-implemented services to users, the clients may store data that may be relevant to the users to the storage/memory resources. When the user-relevant data is stored (temporarily or permanently), the user-relevant data may be subjected to loss, inaccessibility, or other undesirable characteristics based on the operation of the storage/memory resources.

To mitigate, limit, and/or prevent such undesirable characteristics, users of the clients (e.g., 110A, 110B, etc.) may enter into agreements (e.g., SLAs) with providers (e.g., vendors) of the storage/memory resources. These agreements may limit the potential exposure of user-relevant data to undesirable characteristics. These agreements may, for example, require duplication of the user-relevant data to other locations so that if the storage/memory resources fail, another copy (or other data structure usable to recover the data on the storage/memory resources) of the user-relevant data may be obtained. These agreements may specify other types of activities to be performed with respect to the storage/memory resources without departing from the scope of the invention.

In one or more embodiments, a networking resource (not shown) may refer to a measurable quantity of a networking-relevant resource type, which can be requested, allocated, and consumed. A networking-relevant resource type may encompass a physical device, a logical intelligence, or a combination thereof, which may provide network connectivity functionality and/or services. Examples of a networking-relevant resource type may include (but not limited to): a network interface card (NIC), a network adapter, a network processor, etc.

In one or more embodiments, a networking resource may provide capabilities to interface a client with external entities (e.g., the infrastructure nodes (e.g., 120A, 120B, etc.)) and to allow for the transmission and receipt of data with those entities. A networking resource may communicate via any suitable form of wired interface (e.g., Ethernet, fiber optic, serial communication etc.) and/or wireless interface, and may utilize one or more protocols (e.g., transport control protocol (TCP), user datagram protocol (UDP), Remote Direct Memory Access, IEEE 801.11, etc.) for the transmission and receipt of data.

In one or more embodiments, a networking resource may implement and/or support the above-mentioned protocols to enable the communication between the client and the external entities. For example, a networking resource may enable the client to be operatively connected, via Ethernet, using a TCP protocol to form a “network fabric”, and may enable the communication of data between the client and the external entities. In one or more embodiments, each client may be given a unique identifier (e.g., an Internet Protocol (IP) address) to be used when utilizing the above-mentioned protocols.

Further, a networking resource, when using a certain protocol or a variant thereof, may support streamlined access to storage/memory media of other clients (e.g., 110A, 110B, etc.). For example, when utilizing remote direct memory access (RDMA) to access data on another client, it may not be necessary to interact with the logical components of that client. Rather, when using RDMA, it may be possible for the networking resource to interact with the physical components of that client to retrieve and/or transmit data, thereby avoiding any higher-level processing by the logical components executing on that client.

In one or more embodiments, a virtualization resource (not shown) may refer to a measurable quantity of a virtualization-relevant resource type (e.g., a virtual hardware component), which can be requested, allocated, and consumed, as a replacement for a physical hardware component. A virtualization-relevant resource type may encompass a physical device, a logical intelligence, or a combination thereof, which may provide computing abstraction functionality and/or services. Examples of a virtualization-relevant resource type may include (but not limited to): a virtual server, a VM, a container, a virtual CPU (vCPU), a virtual storage pool, etc.

In one or more embodiments, a virtualization resource may include a hypervisor (e.g., a VM monitor), in which the hypervisor may be configured to orchestrate an operation of, for example, a VM by allocating computing resources of a client (e.g., 110A, 110B, etc.) to the VM. In one or more embodiments, the hypervisor may be a physical device including circuitry. The physical device may be, for example (but not limited to): a field-programmable gate array (FPGA), an application-specific integrated circuit, a programmable processor, a microcontroller, a digital signal processor, etc. The physical device may be adapted to provide the functionality of the hypervisor. Alternatively, in one or more of embodiments, the hypervisor may be implemented as computer instructions stored on storage/memory resources of the client that when executed by processing resources of the client cause the client to provide the functionality of the hypervisor.

In one or more embodiments, a client (e.g., 110A, 110B, etc.) may be, for example (but not limited to): a physical computing device, a smartphone, a tablet, a wearable, a gadget, a closed-circuit television (CCTV) camera, a music player, a game controller, etc. Different clients may have different computational capabilities. In one or more embodiment's, Client A (110A) may have 16 gigabytes (GB) of DRAM and 1 CPU with 12 cores, whereas Client N (110N) may have 8 GB of PMEM and 1 CPU with 16 cores. Other different computational capabilities of the clients not listed above may also be taken into account without departing from the scope of the invention.

Further, in one or more embodiments, a client (e.g., 110A, 110B, etc.) may be implemented as a computing device (e.g., 500, FIG. 5). The computing device may be, for example, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the client described throughout the application.

Alternatively, in one or more embodiments, the client (e.g., 110A, 110B, etc.) may be implemented as a logical device (e.g., a VM). The logical device may utilize the computing resources of any number of computing devices to provide the functionality of the client described throughout this application.

In one or more embodiments, users may interact with (or operate) clients (e.g., 110A, 110B, etc.) in order to perform work-related tasks (e.g., production workloads). In one or more embodiments, the accessibility of users to the clients may depend on a regulation set by an administrator of the clients. To this end, each user may have a personalized user account that may, for example, grant access to certain data, applications, and computing resources of the clients. This may be realized by implementing the virtualization technology. In one or more embodiments, an administrator may be a user with permission (e.g., a user that has root-level access) to make changes on the clients that will affect other users of the clients.

In one or more embodiments, for example, a user may be automatically directed to a login screen of a client when the user connected to that client. Once the login screen of the client is displayed, the user may enter credentials (e.g., username, password, etc.) of the user on the login screen. The login screen may be a graphical user interface (GUI) generated by a visualization module (not shown) of the client. In one or more embodiments, the visualization module may be implemented in hardware (e.g., circuitry), software, or any combination thereof.

In one or more embodiments, a GUI may be displayed on a display of a computing device (e.g., 500, FIG. 5) using functionalities of a display engine (not shown), in which the display engine is operatively connected to the computing device. The display engine may be implemented using hardware, software, or any combination thereof. The login screen may be displayed in any visual format that would allow the user to easily comprehend (e.g., read and parse) the listed information.

In one or more embodiments, an infrastructure node (e.g., 120A) of the infrastructure nodes may include (i) a chassis configured to house one or more servers (or blades) and their components and (ii) any instrumentality or aggregate of instrumentalities operable to compute, classify, process, transmit, receive, retrieve, originate, switch, store, display, manifest, detect, record, reproduce, handle, and/or utilize any form of data for business, management, entertainment, or other purposes.

In one or more embodiments, an infrastructure node (e.g., 120A) of the infrastructure nodes may include functionality to, e.g.: (i) obtain (or receive) data (e.g., any type and/or quantity of input) from any source (and, if necessary, aggregate the data); (ii) perform complex analytics and analyze data that is received from one or more clients (e.g., 110A, 110B, etc.) to generate additional data that is derived from the obtained data without experiencing any middleware and/or hardware limitations; (iii) provide meaningful information (e.g., one or more responses) back to the corresponding clients; (iv) filter data (e.g., received from a client) before pushing the data (and/or the derived data) to the long-term storage (140) for management of the data and/or for storage of the data (while pushing the data, the infrastructure node may include information regarding a source of the data (e.g., an identifier of the source) so that such information may be used to associate provided data with one or more of the users (or data owners)); (v) host and maintain various workloads; (vi) provide a computing environment whereon workloads may be implemented (e.g., employing a linear, non-linear, and/or machine learning (ML) model to perform cloud-based data processing); (vii) incorporate strategies (e.g., strategies to provide VDI capabilities) for remotely enhancing capabilities of the clients; (viii) provide robust security features to the clients and make sure that a minimum level of service is always provided to a user of a client; (ix) transmit the result(s) of the computing work performed (e.g., real-time business insights, equipment maintenance predictions, other actionable responses, etc.) to another infrastructure node (e.g., 120N) for review and/or other human interactions; (x) exchange data with other devices registered in/to the network (130) in order to, for example, participate in a collaborative workload placement (e.g., the node may split up a request (e.g., an operation, a task, an activity, etc.) with another node (e.g., 120N), coordinating its efforts to complete the request more efficiently than if the node had been responsible for completing the request); (xi) provide software-defined data protection for clients (e.g., 110A, 110B, etc.); (xii) provide automated data discovery, protection, management, and recovery operations for clients; (xiii) monitor operational states of clients; (xiv) regularly back up configuration information of clients to the long-term storage; (xv) provide (e.g., via a broadcast, multicast, or unicast mechanism) information (e.g., a location identifier, the amount of available resources, etc.) associated with the node to other nodes (e.g., 120B, 120N, etc.) in the system (100); (xvi) configure or control any mechanism that defines when, how, and what data to provide to clients and/or long-term storage; (xvii) provide data deduplication; (xviii) orchestrate data protection through one or more GUIs; (xix) empower data owners (e.g., users of the clients) to perform self-service data backup and restore operations from their native applications; (xx) ensure compliance and satisfy different types of service level objectives (SLOs) set by an administrator/user; (xxi) increase resiliency of an organization by enabling rapid recovery or cloud disaster recovery from cyber incidents; (xxii) provide operational simplicity, agility, and flexibility for physical, virtual, and cloud-native environments; (xxiii) consolidate multiple data process or protection requests (received from, for example, clients) so that duplicative operations (which may not be useful for restoration purposes) are not generated; (xxiv) initiate multiple data process or protection operations in parallel (e.g., the node may host multiple operations, in which each of the multiple operations may (a) manage the initiation of a respective operation and (b) operate concurrently to initiate multiple operations); and/or (xxv) manage operations of one or more clients (e.g., receiving information from the clients regarding changes in the operation of the clients) to improve their operations (e.g., improve the quality of data being generated, decrease the computing resources cost of generating data, etc.). In one or more embodiments, in order to read, write, or store data, the infrastructure node (e.g., 120A) may communicate with, for example, the long-term storage (140) and/or other databases.

In one or more embodiments, monitoring the operational states of clients (e.g., 110A, 110B, etc.) may be used to determine whether it is likely that the monitoring of the scenes by the clients results in information regarding the scenes that accurately reflects the states of the scenes (e.g., a client may provide inaccurate information regarding a monitored scene). Said another way, by providing monitoring services, the infrastructure node (e.g., 120A) may be able to determine whether a client is malfunctioning (e.g., the operational state of a client may change due to a damage to the client, malicious action (e.g., hacking, a physical attack, etc.) by third-parties, etc.). If the client is not in the predetermined operational state (e.g., if the client is malfunctioning), the infrastructure node may take action to remediate the client. Remediating the client may result in the client being placed in the predetermined operational state which improves the likelihood that monitoring of the scene by the client results in the generation of accurate information regarding the scene.

As described above, an infrastructure node (e.g., 120A) of the infrastructure nodes may be capable of providing a range of functionalities/services to the users of clients (e.g., 110A, 110B, etc.). However, not all of the users may be allowed to receive all of the services. To manage the services provided to the users of the clients, a system (e.g., a service manager) in accordance with embodiments of the invention may manage the operation of a network (e.g., 130), in which the clients are operably connected to the infrastructure node. Specifically, the service manager (i) may identify services to be provided by the infrastructure node (for example, based on the number of users using the clients) and (ii) may limit communications of the clients to receive infrastructure node provided services.

For example, the priority (e.g., the user access level) of a user may be used to determine how to manage computing resources of the infrastructure node (e.g., 120A) to provide services to that user. As yet another example, the priority of a user may be used to identify the services that need to be provided to that user. As yet another example, the priority of a user may be used to determine how quickly communications (for the purposes of providing services in cooperation with the internal network (and its subcomponents)) are to be processed by the internal network.

Further, consider a scenario where a first user is to be treated as a normal user (e.g., a non-privileged user, a user with a user access level/tier of 4/10). In such a scenario, the user level of that user may indicate that certain ports (of the subcomponents of the network (130) corresponding to communication protocols such as the TCP, the UDP, etc.) are to be opened, other ports are to be blocked/disabled so that (i) certain services are to be provided to the user by the infrastructure node (e.g., 120A) (e.g., while the computing resources of the infrastructure node may be capable of providing/performing any number of remote computer-implemented services, they may be limited in providing some of the services over the network (130)) and (ii) network traffic from that user is to be afforded a normal level of quality (e.g., a normal processing rate with a limited communication bandwidth (BW)). By doing so, (i) computer-implemented services provided to the users of the clients (e.g., 110A, 110B, etc.) may be granularly configured without modifying the operation(s) of the clients and (ii) the overhead for managing the services of the clients may be reduced by not requiring modification of the operation(s) of the clients directly.

In contrast, a second user may be determined to be a high priority user (e.g., a privileged user, a user with a user access level of 9/10). In such a case, the user level of that user may indicate that more ports are to be opened than were for the first user so that (i) the infrastructure node (e.g., 120A) may provide more services to the second user and (ii) network traffic from that user is to be afforded a high-level of quality (e.g., a higher processing rate than the traffic from the normal user).

As used herein, a “workload” is a physical or logical component configured to perform certain work functions. Workloads may be instantiated and operated while consuming computing resources allocated thereto. A user may configure a data protection policy for various workload types. Examples of a workload may include (but not limited to): a data protection workload, a VM, a container, a network-attached storage (NAS), a database, an application, a collection of microservices, a file system (FS), small workloads with lower priority workloads (e.g., FS host data, OS data, etc.), medium workloads with higher priority (e.g., VM with FS data, network data management protocol (NDMP) data, etc.), large workloads with critical priority (e.g., mission critical application data), etc.

Further, while a single infrastructure node (e.g., 120A) is considered above, the term “node” includes any collection of systems or sub-systems that individually or jointly execute a set, or multiple sets, of instructions to provide one or more computer-implemented services. For example, a single infrastructure node may provide a computer-implemented service on its own (i.e., independently) while multiple other nodes may provide a second computer-implemented service cooperatively (e.g., each of the multiple other nodes may provide similar and or different services that form the cooperatively provided service).

As described above, an infrastructure node (e.g., 120A) of the infrastructure nodes may provide any quantity and any type of computer-implemented services. To provide computer-implemented services, the infrastructure node may be a heterogeneous set, including a collection of physical components/resources (discussed above) configured to perform operations of the node and/or otherwise execute a collection of logical components/resources (discussed above) of the node.

In one or more embodiments, an infrastructure node (e.g., 120A) of the infrastructure nodes may implement a management model to manage the aforementioned computing resources in a particular manner. The management model may give rise to additional functionalities for the computing resources. For example, the management model may be automatically store multiple copies of data in multiple locations when a single write of the data is received. By doing so, a loss of a single copy of the data may not result in a complete loss of the data. Other management models may include, for example, adding additional information to stored data to improve its ability to be recovered, methods of communicating with other devices to improve the likelihood of receiving the communications, etc. Any type and numbers of management models may be implemented to provide additional functionalities using the computing resources without departing from the scope of the invention.

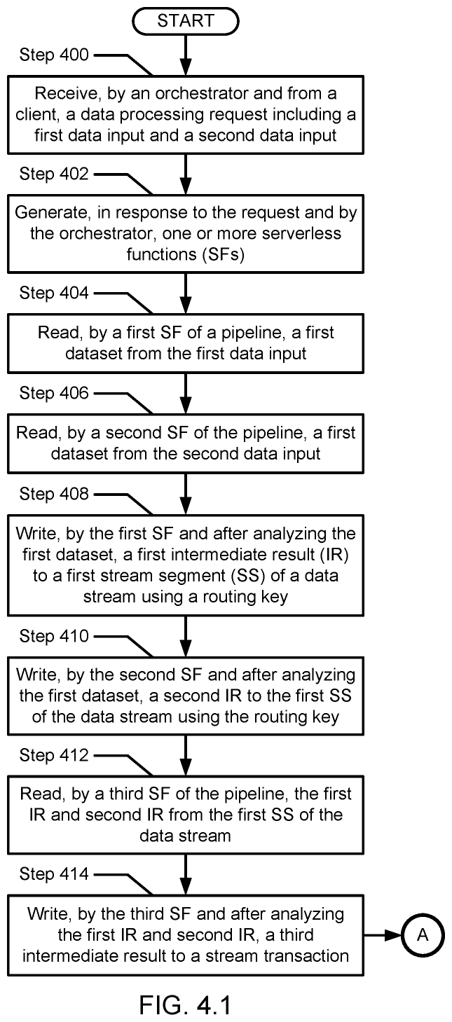

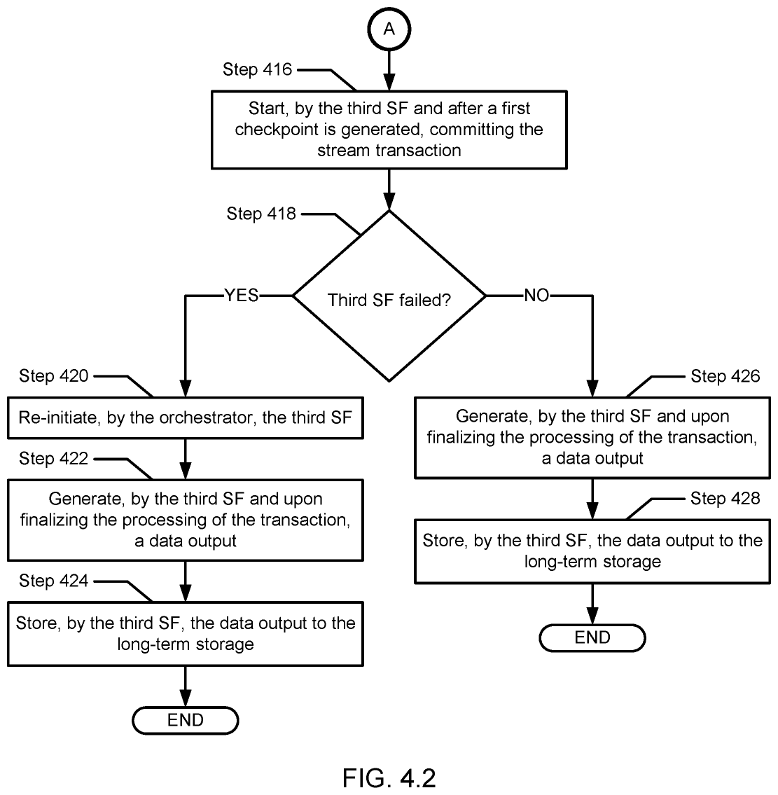

One of ordinary skill will appreciate that an infrastructure node (e.g., 120A) of the infrastructure nodes may perform other functionalities without departing from the scope of the invention. In one or more embodiments, the node may be configured to perform (in conjunction with the streaming storage system (125)) all, or a portion, of the functionalities described in FIGS. 4.1 and 4.2.

In one or more embodiments, an infrastructure node (e.g., 120A) of the infrastructure nodes may be implemented as a computing device (e.g., 500, FIG. 5). The computing device may be, for example, a mobile phone, a tablet computer, a laptop computer, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the infrastructure node described throughout the application.

Alternatively, in one or more embodiments, similar to a client (e.g., 110A, 110B, etc.), the infrastructure node may also be implemented as a logical device.

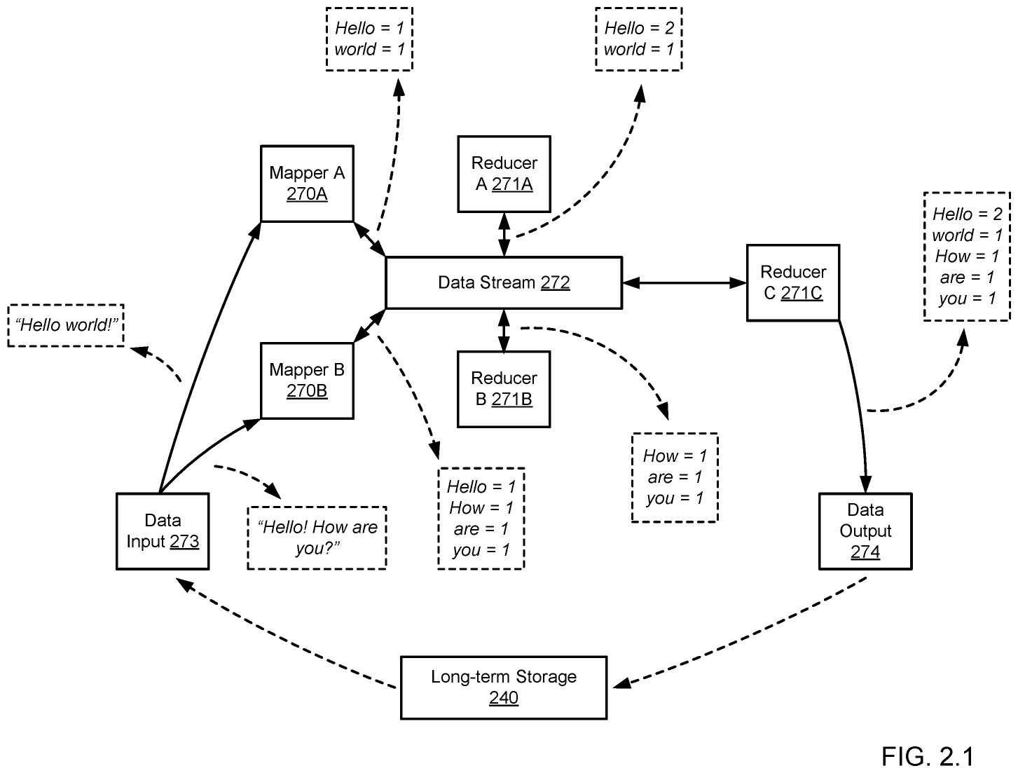

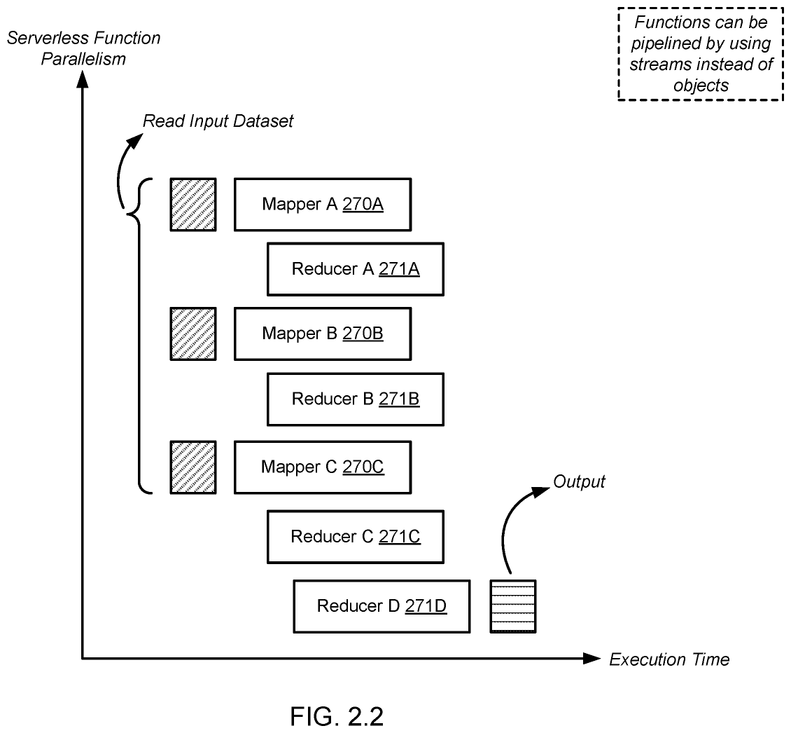

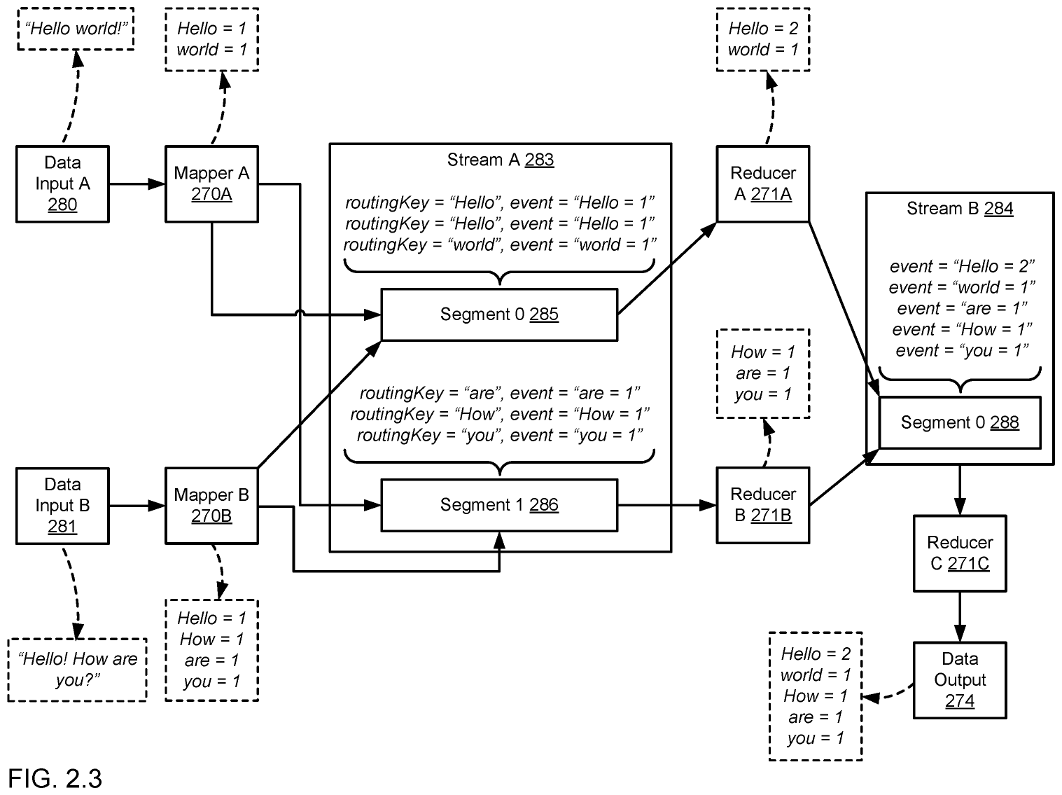

In one or more embodiments, an infrastructure node (e.g., 120A) of the infrastructure nodes may host an orchestrator (127). Additional details of the orchestrator are described below in reference to FIGS. 2.1 and 2.3. In the embodiments of the present disclosure, the streaming storage system (125) is demonstrated as a separate entity from the infrastructure nodes; however, embodiments herein are not limited as such. The streaming storage system may be demonstrated as a part of the infrastructure node (e.g., as deployed to the node). Additional details of the streaming storage system are described below in reference to FIG. 1.2. Similarly, in the embodiments of the present disclosure, the orchestrator (127) is demonstrated as a part of the infrastructure node (e.g., as deployed to the node); however, embodiments herein are not limited as such. The orchestrator may be a separate entity from the infrastructure node.

In one or more embodiments, all, or a portion, of the components of the system (100) may be operably connected each other and/or other entities via any combination of wired and/or wireless connections. For example, the aforementioned components may be operably connected, at least in part, via the network (130).

In one or more embodiments, the network (130) may represent a (decentralized or distributed) computing network and/or fabric configured for computing resource and/or messages exchange among registered computing devices (e.g., the clients, the infrastructure node, etc.). As discussed above, components of the system (100) may operatively connect to one another through the network (e.g., a storage area network (SAN), a personal area network (PAN), a LAN, a metropolitan area network (MAN), a WAN, a mobile network, a wireless LAN (WLAN), a virtual private network (VPN), an intranet, the Internet, etc.), which facilitates the communication of signals, data, and/or messages. In one or more embodiments, the network may be implemented using any combination of wired and/or wireless network topologies, and the network may be operably connected to the Internet or other networks. Further, the network (130) may enable interactions between, for example, the clients and the infrastructure node through any number and type of wired and/or wireless network protocols (e.g., TCP, UDP, IPv4, etc.).

The network (130) may encompass various interconnected, network-enabled subcomponents (not shown) (e.g., switches, routers, gateways, cables etc.) that may facilitate communications between the components of the system (100). In one or more embodiments, the network-enabled subcomponents may be capable of: (i) performing one or more communication schemes (e.g., IP communications, Ethernet communications, etc.), (ii) being configured by one or more components in the network, and (iii) limiting communication(s) on a granular level (e.g., on a per-port level, on a per-sending device level, etc.). The network (130) and its subcomponents may be implemented using hardware, software, or any combination thereof.

Turning now to FIG. 1.2, FIG. 1.2 shows a diagram/architecture of the streaming storage system (125) in accordance with one or more embodiments of the invention. The streaming storage system (125) (e.g., Dell Pravega or simply “Pravega”) includes a controller (162), a logger (166) (e.g., a bookkeeper service), a segment store (SS) (164), and a consensus service (168) (e.g., a zookeeper service). The streaming storage system (125) may include additional, fewer, and/or different components without departing from the scope of the invention. For example, based on the amount of available computing resources in the infrastructure node (e.g., 120, FIG. 1.1), the streaming storage system (125) may host multiple controllers, segment containers (SCs) (e.g., 165A, 165B, etc.), and/or SSs executing contemporaneously, e.g., distributed across multiple servers, VMs, or containers, for scalability and fault tolerance. Each component may be operably connected to any of the other component via any combination of wired and/or wireless connections. Each component illustrated in FIG. 1.2 is discussed below.

The embodiment shown in FIG. 1.2 may show a scenario in which (i) one or more SCs (e.g., 165A, 165B, etc.) are distributed across the SS (164) and (ii) the streaming storage system (125) is an independent system (e.g., meaning that the streaming storage system may customize the resource usage of the SS independently, in an isolated manner).

In one or more embodiments, the streaming storage system (125) allows users (via clients (e.g., Client A (110A))) to ingest data and execute real-time analytics/processing on that data (while guaranteeing data consistency and durability (e.g., once acknowledged, data is never lost)). With the help of the SS (164), the data may be progressively moved to the long-term storage (140) so that users may have access to the data to perform large-scale batch analytics, for example, on a cloud (with more resources). Users may define clusters that execute a subset of assigned SCs across the system (e.g., 100, FIG. 1.1) so that different subsets of SCs may be executed on independent clusters (which may be customized in terms of instances and resources per-instance) to adapt different kinds of workloads and hardware components.

In one or more embodiments, the controller (162) may represent a “control plane” and the SS (164) may represent a “data plane”. The SS (164) may execute/host, at least, SC A (165A) and SC (165B) (as “active” SCs, so they may serve write/read operations), in which an SC is a unit of parallelism in Pravega (or a unit of work of a SS) and is responsible for executing any storage or metadata operations against the segments (described below) allocated in it. Due to the design characteristics of Pravega (e.g., with the help of the integrated storage tiering mechanism of Pravega), the SS (164) may store data to the long-term storage (140), in which the tiering storage may be useful to provide instant access to recent stream data. Although not shown, the streaming storage system may include one or more processors, buses, and/or other components without departing form the scope of the invention.

In one or more embodiments, an SC may represent how Pravega partitions a workload (e.g., a logical partition of the workload at the data plane) in order to host segments of streams. Once (automatically) initialized/initiated, an SC may keep executing on its corresponding SS (e.g., a physical component) to perform one or more operations, where, for example, Client A (110A) may not be aware of what the location of an SC in Pravega (e.g., in case Client A wants to generate a new stream with a segment).

In one or more embodiments, depending on the resource capabilities (or resource related parameters) of the infrastructure node (e.g., 120, FIG. 1.1) (which may be customized over time), the SS (164) (and the SCs hosted by that SS) may provide different functionalities (e.g., providing a better performance). For example, a resource related parameter may include (or specify), for example (but not limited to): a configurable CPU option (e.g., a valid/legitimate virtual CPU count per SS), a configurable network resource option (e.g., allowability of enabling/disabling single-root input/output virtualization (SR-IOV) for specific APIs), a configurable memory option (e.g., maximum and minimum memory per SS), a configurable GPU option (e.g., allowable scheduling policy and/or virtual GPU count combinations), a configurable DPU option (e.g., legitimacy of disabling inter-integrated circuit (I2C) for different SSs), a user type, a network resource related template (e.g., a 10 GB/s BW with 20 ms latency QoS template, a 10 GB/s BW with 10 ms latency QoS template, etc.), a DPU related template (e.g., a 1 GB/s BW vDPU with 1 GB vDPU frame buffer template, a 2 GB/s BW vDPU with 1 GB vDPU frame buffer template, etc.), a GPU related template (e.g., a depth-first vGPU with 1 GB vGPU frame buffer template, a depth-first vGPU with 2 GB vGPU frame buffer template, etc.), a CPU related template (e.g., a 1 vCPU with 4 cores template, a 2 vCPUs with 4 cores template, etc.), a memory related template (e.g., a 4 GB DRAM template, an 8 GB DRAM template, etc.), a vCPU count per SS (e.g., 2, 4, 8, 16, etc.), a speed select technology configuration (e.g., enabled, disabled, etc.), an SS IOMMU configuration (e.g., enabled, disabled, etc.), a wake on LAN support configuration (e.g., supported/enabled, not supported/disabled, etc.), a reserved memory configuration (e.g., as a percentage of configured memory such as 0-100%), a memory ballooning configuration (e.g., enabled, disabled, etc.), a vGPU count per SS (e.g., 1, 2, 4, 8, etc.), a type of a vGPU scheduling policy (e.g., a “fixed share” vGPU scheduling policy, an “equal share” vGPU scheduling policy, etc.), a type of a GPU virtualization approach (e.g., graphics vendor native drivers approach such as a vGPU, hypervisor-enabled drivers approach such as virtual shared graphics acceleration (vSGA), etc.), a user profile folder redirection configuration (e.g., a local user profile, a profile redirection, etc.), a number of SCs available to perform an operation (e.g., 0, 10, 20, etc.), etc.

In one or more embodiments, the control plane may include functionality to, e.g.: (i) in conjunction with the data plane, generate, alter, and/or delete streams; (ii) retrieve information about streams; and/or (iii) monitor health of a Pravega cluster (described below) by gathering metrics. Further, the SS (164) may provide an API to read/write data in streams.

In one or more embodiments, a stream (described below) may be partitioned/decomposed into stream segments (or simply “segments”). A stream may have one or more segments (where each segment may be stored in a combination of tier-1 storage and tier-2 storage), in which data/event written into the stream may be written into exactly one of the segments based on the event's routing key (e.g., “writer.writeEvent(routingkey, message)”). In one or more embodiments, writers (e.g., of Client A (110A)) may use routing keys (e.g., user identifier, timestamp, machine identifier, etc., to determine a target segment for a stream write operation) so that data is grouped together.

In one or more embodiments, based on the inherent capabilities of the streaming storage system (125) (e.g., Pravega), data streams may have multiple open segments in parallel (e.g., enabling the data stream parallelism), both for ingesting and consuming data. The number of parallel stream segments in a stream may automatically grow and shrink over time based on the I/O load the stream receives, so that the parallelism of the stream may be modified based on the number of serverless functions to be executed, if needed.

As described above, a data stream with one or more segments may support parallelism of data writes, in which multiple writers (or multiple writer components) writing data to different segments may exploit/involve one or more servers hosted in a Pravega cluster (e.g., one or more servers, the controller (162), and the SS (164) may collectively be referred to as a “Pravega cluster”, in which the Pravega cluster may be coordinated to execute Pravega). In one or more embodiments, a consistent hashing scheme may be used to assign incoming events to their associated segments (such that each event is mapped to only one of the segments based on “user-provided” or “event” routing key), in which event routing keys may be hashed to form “key space” and the key space may be divided into a number of partitions, corresponding to the number of segments. Additionally, each segment may be associated with only one instance of SS (e.g., the SS (164)).

In one or more embodiments, from the perspective of a reader component (e.g., Client A (110A) may include a writer component and a reader component), the number of segments may represent the maximum degree of read parallelism possible (e.g., all the events from a set of streams will be read by only one reader in a “reader group (RG)”. If a stream has N segments, then an RG with N reader components may consume from the stream in parallel (e.g., for any RG reading a stream, each segment may be assigned to one reader component in that RG). In one or more embodiments, increasing the number of segments may increase the number of readers in an RG to increase the scale of processing the data from that stream, whereas, as the number of segments decreases, the number of readers may be reduced.

In one or more embodiments, a reader component may read from a stream either at the tail of the stream or at any part of the stream's historical data. Unlike log-based systems that use the same kind of storage for tail reads/writes as well as reads to historical data, a tail of a stream may be kept in tier-1 storage, where write operations may be implemented by the logger (166) as described herein. In some cases (e.g., when a failure has occurred and the system is being recovered), the logger may serve read operations.

In one or more embodiments, the streaming storage system (125) (e.g., Pravega) may implement exactly-once semantics (or “exactly once delivery semantics”), which means data is delivered and processed exactly-once (with exact ordering guarantees), despite failures in, for example, Client A (110A), servers, serverless functions (e.g., Mapper A (e.g., 270A, FIG. 2.1), Reducer A (e.g., 271A, FIG. 2.1), etc.), and/or the network. To achieve exactly-once semantics, streams may be durable, ordered, consistent, and/or transactional (e.g., embodiments of the invention may enable durable storage of streaming data with strong consistency, ordering guarantees, and high-performance).

As used herein, “ordering” may mean that data is read by reader components in the order it is written. In one or more embodiments, data may be written along with an application-defined routing key, in which the ordering guarantee may be made in terms of routing keys (e.g., a write order may be preserved by a routing key, which may facilitate write parallelism). For example, two pieces of data with the same routing key may be read by a reader in the order they were written. In one or more embodiments, Pravega (more specifically, the SS (164)) may enable an ordering guarantee to allow data reads to be replayed (e.g., when applications fail) and the results of replaying the reads (or the read processes) may be the same.

As used herein, “consistency” may mean that reader components read the same ordered view of data for a given routing key, even in the case of a failure (without missing any data/event). In one or more embodiments, Pravega (more specifically, the SS (164)) may perform idempotent write processes, where rewrites performed as a result of failure recovery may not result in data duplication (e.g., a write process may be performed without suffering from the possibility of data duplication (and storage overhead) on reconnections).

In one or more embodiments, the SS (164) may automatically (e.g., elastically and independently) scale individual data streams to accommodate changes in a data ingestion rate. The SS may enable shrinking of write latency to milliseconds, and may seamlessly handle high-throughput reads/writes from Client A (110A), making the SS ideal for IoT and other time-sensitive implementations. For example, consider a scenario where an IoT application receives information from hundreds of devices feeding thousands of data streams. In this scenario, the IoT application processes those streams to derive a business value from all that raw data (e.g., predicting device failures, optimizing service delivery through those devices, tailoring a user's experience when interacting with those devices, etc.). As indicated, building such an application at scale is difficult without having the components be able to scale automatically as the rate of data increases and decreases.

In one or more embodiments, a data stream may be configured to grow the number of segments as more data is written to the stream, and to shrink when data volume drops off. In one or more embodiments, growing and shrinking a stream may be performed based on a stream's SLO (e.g., to match the behavior of data input). For example, the SS (164) may enable monitoring a rate of data ingest/input to a stream and use the SLO to add or remove segments from the stream. In one or more embodiments, (i) segments may be added by splitting a segment/shard/partition of a stream (e.g., scaling may cause an existing segment, stored at the related data storage thus far, to be split into plural segments; scaling may cause an existing event, stored at the corresponding data storage thus far, to be split into plural events; etc.), (ii) segments may be removed by merging two segments (e.g., scaling may cause multiple existing segments to be merged into a new segment; scaling may cause multiple existing events to be merged into a new event; etc.), and/or (iii) the number of segments may vary over time (e.g., to deal with a potentially large amount of information in a stream). Further, a configuration of a writer component may not change when segments are split or merged, and a reader component may be notified via a stream protocol when segments are split or merged to enable reader parallelism.

In one or more embodiments, Client A (110A) may send metadata requests to the controller (162) and may send data requests (e.g., write requests, read requests, create a stream, delete the stream, get the segments, etc.) to the SS (164). With respect to a “write path” (which is primarily driven by a sequential write performance of the logger (166)), the writer component of Client A (110A) may first communicate with the controller (162) to perform a write operation (e.g., appending events/data) and to infer which SS it supposed to connect to. Based on that, the writer component may connect to the SS (164) to start appending data. Thereafter, the SS (164) (more specifically, SCs hosted by the SS) may first write data (synchronously) to the logger (166) (e.g., the “tier-1 storage” of Pravega (which typically executes within the Pravega cluster), Apache Bookkeeper, a distributed write ahead log, etc.) to achieve data durability (e.g., in the presence of small write operations) and low-latency (e.g., <10 milliseconds) before acknowledging the writer component on every data written (so that data may not be lost as data is saved in protected, persistent/temporary storage before the write operation is acknowledged).

Once acknowledged, in an offline process, the SS (164) may group the data (written to the logger (166) into larger chunks and asynchronously move the larger chunks to the long-term storage (140) (e.g., the “tier-2 storage” of Pravega, pluggable storage, AWS S3, Apache HDFS, Dell Isilon, Dell ECS, object storage, block storage, file system storage, etc.) for high read/write throughput (e.g., to perform batch analytics) (as indicated, Client A (110A) may not directly write to tier-2 storage) and for permanent data storage. For example, Client A may send a data request for storing and processing video data from a surgery in real-time (e.g., performing computations (or real-time analytics) on the video data captured by surgery cameras for providing augmented reality capabilities on the video data to help surgeons, where SC A (165A) may be used for this purpose), and eventually, this data may need to be available (or permanently stored) on a larger IT facility that hosts enough storage/memory and compute resources (e.g., for executing batch analytics on historical video data to train ML models, where the video data may be asynchronously available in the tier-2 storage).

Further, with respect to a “read path” (which is isolated from the write path), the reader component of Client A (110A) may first communicate with the controller (162) to perform a read operation and to infer which SS it supposed to connect to (e.g., via its memory cache, the SS (164) may indicate where it keeps the data such that the SS may serve tail of data from the cache). For example, if the data is not cached (e.g., historical data), the SS may pull data from the long-term storage (140) so that the reader component performs the read operation (as indicated, the SS may not use the logger (166) to serve a read request of the reader component, where the data in the logger may be used for recovery purposes when necessary).

In one or more embodiments, once data is (and/or will be) provided by Client A (110A) to the SS (164), users may desire access to the data managed by the SS. To facilitate provisioning of access to the data, the SS may manage one or more data structures (in conjunction with the logger (166)), such as block chains, that include information, e.g.: (i) related to data ownership, (ii) related to the data that is managed, (iii) related to users (e.g., data owners), and/or (iv) related to how users may access the stored data. In one or more embodiments, by providing data management services and/or operational management services (in conjunction with the logger) to the users and/or other entities, the SS may enable any number of entities to access data. As part of providing the data management services, the SS may provide (in conjunction with the logger and/or the long-term storage (140)) a secure method for storing and accessing data. By doing so, access to data in the logger may be provided securely while facilitating provisioning of access to the data.

The data management services and/or operational management services provided by the SS (164) (through, for example, its SCs) may include, e.g.: (i) obtaining data requests and/or data from Client A (110A) (where, for example, Client A performs a data write operation through a communication channel); (ii) organizing and/or writing/storing the “obtained” data (and metadata regarding the data) to the logger (166) to durably store the data; (iii) generating derived data based on the obtained data (e.g., grouping the data into larger chunks by employing a set of linear, non-linear, and/or ML models), (iv) providing/moving the obtained data, derived data, and/or metadata associated with both data to the long-term storage (140); (v) managing when, how, and/or what data Client A may provide; (vi) temporarily storing the obtained data in its cache for serving that data to reader components; and/or (vii) queueing one or more data requests.

In one or more embodiments, as being part of the tiered storage streaming system (e.g., tier-1 (durable) storage), the logger (166) may provide short-term, low-latency data storage/protection while preserving/guaranteeing the durability and consistency of data written to streams. In some embodiments, the logger may exist/execute within the Pravega cluster. As discussed above, the SS (164) may enable low-latency, fast, and durable write operations (e.g., data is replicated and persisted to disk before being acknowledged) to return an acknowledgement to a writer component (e.g., of Client A (110A)), and these operations may be optimized (in terms of I/O throughput) with the help of the logger.

In one or more embodiments, to add further efficiency, write operations to the logger (166) may involve data from multiple segments, so the cost of persisting data to disk may be amortized over several write operations. The logger may persist the most recently written stream data (to make sure reading from the tail of a stream can be performed as fast as possible), and as data in the logger ages, the data may be moved to the long-term storage (140) (e.g., a tail of a segment may be stored in tier-1 storage providing low-latency reads/writes, whereas the rest of the segment may be stored in tier-2 storage providing high-throughput read access with near-infinite scale and low-cost). Further, the Pravega cluster may use the logger as a coordination mechanism for its components, where the logger may rely on the consensus service (168).

One of ordinary skill will appreciate that the logger (166) may perform other functionalities without departing from the scope of the invention. The logger may be implemented using hardware, software, or any combination thereof.

In one or more embodiments, in case of reads, SC A (165A) may have a “read index” that tracks the data read for the related segments, as well what fraction of that data is stored in cache. If a read process (e.g., initiated upon receiving a read request) requests data for a segment that is not cached, the read index may trigger a read process against the long-term storage (140) to retrieve that data, storing it in the cache, in order to serve Client A (110A).

As used herein, data may refer to a “stream data (or a “stream”)” that is a continuous (or continuously generated), unbounded (in size), append-only (e.g., data in a stream cannot be modified but may be truncated, meaning that segments are indivisible units that form the stream), lightweight (e.g., as a file), and durable sequence of bytes (e.g., a continuous data flow/structure that may include data, metadata, and/or the like; a collection of data records called “events”, in which there may not be a limit on how many events can be in a stream or how many total bytes are stored in a stream; etc.) generated (in parallel) by one or more data sources (e.g., 110A, 110B, IoT sensors, etc.). In one or more embodiments, by using append-only log data structures (which are useful for serverless computing frameworks while supporting real-time and historical data access), the SS (164) may enable rapid ingestion of information into durable storage (e.g., the logger (166)) and support a large variety of application use cases (e.g., publish/subscribe messaging, NoSQL databases, event-oriented applications, etc.). Further, a writer component may keep inserting events at one end of a stream and a reader component may keep reading the latest ones from there or for historical reads, the reader component may target specific offsets and keep reading from there.

As used herein, serverless computing frameworks may refer to FaaS platforms, which allow users to focus only on their code and implementation of the code at a large scale without having to worry about the infrastructure and/or resource management. In most cases, FaaS platforms provide reactive approaches to execute functions (i.e., based events) and to enable stateless computations (e.g., when the execution halts, the “serverless” function may not keep anything in memory unless the function wrote the related data to object storage). Due to their stateless and short-lived nature, serverless functions may need to transfer the results of their computations to other functions via an intermediate system.

While for small computations there may be multiple options (e.g., messaging systems, queues, etc.), for data-intensive FaaS pipelines that manage larger amounts of data (e.g., video files, audio files, images, large text files, etc.), the conventional approach is to store intermediate results as objects in object storage. However, the problem with the conventional approach is that there is a mismatch between the design of the pipeline and the storage layer used by it. The pipeline of data-intensive functions may exploit the fact of using data streams as a substrate for improving latency and processing results byte-by-byte. However, using object storage may force a computation step/stage to be completed and store its results as objects (in object storage) for the next step of functions to be triggered. This may induce additional latency that impact on the overall performance of the pipeline. In the case of a failure, using the object storage (as a storage layer for intermediate function results) may provide no mechanism for guaranteeing exactly-once semantics in the pipeline. That this, if there is a failure in the execution of the pipeline, data may be processed twice or some data may be missed to generate the result, and one or more embodiments disclosed herein advantageously overcome these issues.

Continuing with the discussion of FIG. 1.2, an event may be a collection of bytes within a stream (or a contiguous set of related extents of unbounded, continuously generated data) (e.g., a small number of bytes including a temperature reading from an IoT sensor composed of a timestamp, a metric identifier, and a value; web data associated with a user click on a website; a timestamped readout from one sensor of a sensor array; etc.). Said another way, events (which are atomic) may be appended to segments of a data stream (e.g., a stream of bytes), where segments are the unit of storage of the data stream (e.g., a data stream may be comprised of one or more segments, where (i) each segment may include one or more events (where a segment may not store events directly, the segment may store the append-only sequence of bytes of the events) and (ii) events may be appended to segments by serializing them into bytes, where once written, that sequence of bytes is immutable). In one or more embodiments, events may be stored along a data stream in parallel to one another and/or in succession to one another (where segments may provide parallelism). That is, one or more events may have data occurring in parallel, or having occurred in parallel. Further, one or more events may sequentially follow one or more other events, such as having data that occurs after one or more other events, or has occurred after data from one or more other events.

In one or more embodiments, the number of segments for appending and/or truncating (e.g., the oldest data from a stream without compromising with the data format) may vary over a respective unit axis of a data stream. It will be appreciated that a data stream may be represented relative to a time axis. That is, data and/or events may be written to and/or appended to a stream continuously, such as in a sequence or in an order. Likewise, such data may be reviewed and/or analyzed by a user in a sequence or in an order (e.g., a data stream may be arranged based upon a predecessor-successor order along the data stream).

Sources of data written, posted, and/or otherwise appended to a stream may include, for example (but not limited to): online shopping applications, social network applications (e.g., producing a stream of user events such as status updates, online transactions, etc.), IoT sensors, video surveillance cameras, drone images, autonomous vehicles, servers (e.g., producing a stream of telemetry information such as CPU utilization, memory utilization, etc.) etc. The data from streams (and thus from the various events appended to the streams) may be consumed, by ingesting, reading, analyzing, and/or otherwise employing in various ways (e.g., by reacting to recent events to analyze historical stream data).

In one or more embodiments, an event may have a routing key, which may be a string that allows Pravega and/or administrators to determine which events are related (and/or which events may be grouped). A routing key may be derived from data, or it may be an artificial string (e.g., a universally unique identifier) or a monotonically increasing number. For example, a routing key may be a timestamp (to group events together by time), or an IoT sensor identifier (to group events by a machine). In one or more embodiments, a routing key may be useful to define precise read/write semantics. For example, (i) events with the same routing key may be consumed in the order they were written and (ii) events with different routing keys sent to a specific reader will always be processed in the same order even if that reader backs up and re-reads them.

As discussed above, Pravega (e.g., an open-source, distributed and tiered streaming storage system providing a cloud-native streaming infrastructure (i) that is formed by controller instances and SS instances, (ii) that eventually stores stream data in a long-term storage (e.g., 140), (iii) that enables auto-scaling of streams (where a degree of parallelism may change dynamically in order to react workload changes) and its connection with serverless computing, and (iv) that supports both a byte stream (allowing data to be access randomly by any byte offset) and an event stream (allowing parallel writes/reads)) may store and manage/serve data streams, in which the “stream” abstraction in Pravega is a first-class primitive for storing continuous and unbounded data. A data stream in Pravega guarantees strong consistency and achieves good performance (with respect to data storage and management), and may be combined with one or more stream processing engines (e.g., Apache Flink) to initiate streaming applications.

In one or more embodiments, Client A (110A) may concurrently have dynamic write/read access to a stream where other clients (using the streaming storage system (125)) may be aware of all changes being made to the stream. The SS (164) may track data that has been written to the stream. Client A may update the stream by sending a request to the SS that includes the update and a total length of the stream that was written at the time of a last read update by Client A. If the total length of the stream received from Client A matches the actual length of the stream maintained by the SS, the SS may update the stream. If not, a failure message may be sent to Client A and Client A may process more reads to the stream before making another attempt to update the stream.

In one or more embodiments, Client A (110A) may provide a client library that may implement an API for the writer and reader components to use (where an application may use the API to read and write data from and to the storage system). The client library may encapsulate a protocol used for a communication between Client A and Pravega (e.g., the controller (162), the SS (164), etc.). As discussed above, (i) a writer component may be an application that generates events/data and writes them into a stream, in which events may be written by appending to the tail (e.g., front) of the stream; (ii) a reader component may be an application that reads events from a stream, in which the reader component may read from any point in the stream (e.g., a reader component may be reading events from a tail of a stream); and (iii) events may be delivered to a reader component as quickly as possible (e.g., events may be delivered to a reader component within tens of milliseconds after they were written).

In one or more embodiments, segments may be illustrated as “Sn” with n being, for example, 1 through 10 (see FIG. 2.3). A low number n indicates a segment location closer to a stream head and a high number n indicates a segment location closer to a stream tail. In general, a stream head refers to the smallest offsets of events that have no predecessor (e.g., the beginning of a stream, the oldest data, etc.). Such events may have no predecessor because either such events are the first events written to a stream or their predecessors have been truncated. Likewise, a stream tail refers to the highest offsets of events of an open stream that has no successor (e.g., the most recently written events and/or last events, the end of a stream where new events are appended, etc.). In one or more embodiments, a segment may be (i) an “open segment” indicating that a writer component may write data to that segment and a reader component may consume that data at a later point-in-time, and (ii) a “sealed/immutable segment” indicating that the segment is read-only (e.g., which may not be appended).

In one or more embodiments, a reader component may read from earlier parts (or at an arbitrary position) of a stream (referred to as “catch-up reads”, where catch-up read data may be cached on demand) and a “position object (or simply a “position”)” may represent a point in the stream that the reader component is currently located.

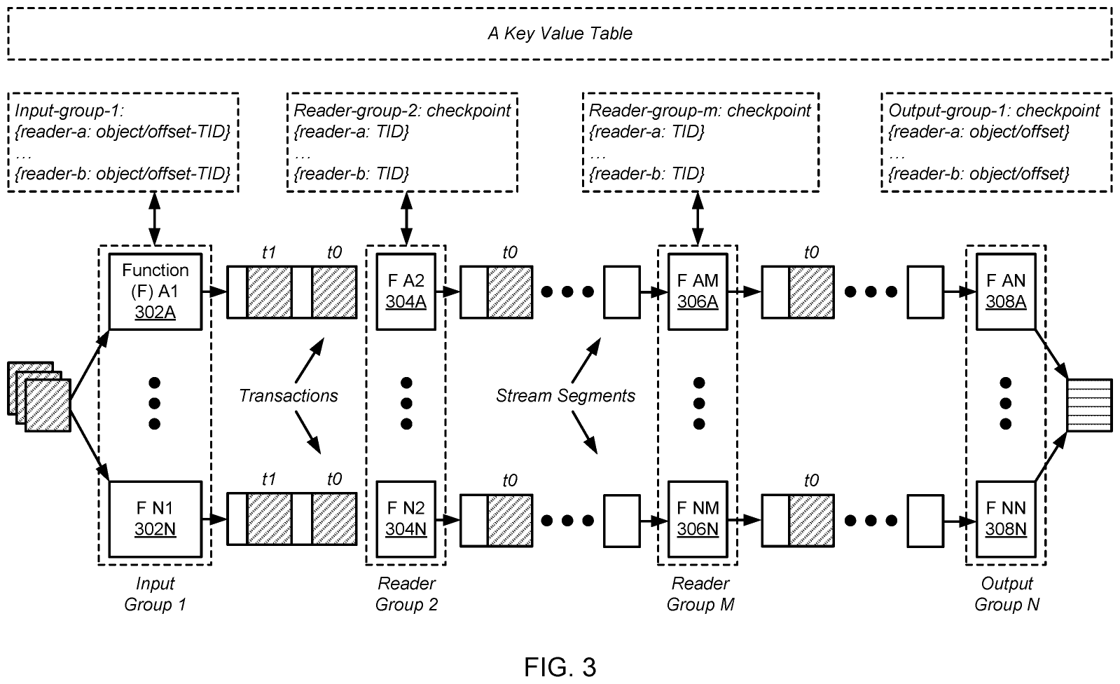

As used herein, a “position” may be used as a recovery mechanism, in which an application (of Client A (110A)) that persist the last position of a “failed” reader component that has successfully processed may use that position to initialize a replacement reader to pick up where the failed reader left off (see FIG. 3). In this manner, the application may provide exactly-once semantics (e.g., exactly-once event processing) in the case of a reader component failure.

In one or more embodiments, multiple reader components may be organized into one or more RGs, in which an RG may be a named collection of readers that together (e.g., in parallel, simultaneously, etc.) read events from a given stream. Each event published into a stream may be guaranteed to be sent to one reader component within an RG. In one or more embodiments, an RG may be a “composite RG” or a “distributed RG”, where the distributed RG may allow a distributed application to read and process data in parallel, such that a massive amount of data may be consumed by a coordinated fleet of reader components in that RG. A reader (or a reader component) in an RG may be assigned zero or more stream segments from which to read (e.g., a segment is assigned to one reader in the RG, which gives the “one segment to one reader” exclusive access), in which the number of stream segments may be balanced to which the reader is assigned. For example, the reader may read from two stream segments while another reader in the RG may only read one stream segment.

In one or more embodiments, reader components may be added to an RG, or reader components fail and may be removed from the RG, and a number of segments in a stream may determine the upper bound of “read” parallelism of readers/reader components within the RG. Further, an application (of Client A (110A)) may be made aware of changes in segments (via the SS (164)). For example, the application may react to changes in the number of segments in a stream (e.g., by adjusting the number of readers in an associated RG) to maintain maximum read parallelism if resources allow.

In one or more embodiments, events may be appended to a stream individually, or may be appended as a stream transaction (no size limit), which is supported by the streaming storage system (125). As used herein, a “transaction” refers to a group/set of multiple events (e.g., a writer component may batch up a bunch of events in the form of a transaction and commit them as a unit into a stream). For example, when the controller (162) invokes committing a transaction (e.g., as a unit into a stream), the group of events included in the transaction may be written (via the writer component) to a stream as a whole (where the transaction may span multiple segments of the stream) or may be abandoned/discarded as a whole (e.g., if the writer component fails). With the use of transactions, a writer component may persist data at a point-in-time, and later decide whether the data should be appended to a stream or abandoned. In one or more embodiments, a transaction may be implemented similar to a stream, in which the transaction may be associated with multiple segments and when an event is published into the transaction, (i) the event itself is appended to a segment of the transaction (where data written to the transaction is just as durable as data written directly to a stream) and (ii) the event may not be visible to a reader component until that transaction is committed. Further, an application may continuously produce results of a data processing operation and use the transaction to durably accumulate the results of the operation.

In one or more embodiments, as being a stateless component, the controller (162) may (further) include functionality to, e.g.: (i) manage the lifecycle of a stream and/or transactions, in which the lifecycle of the stream includes features such as generation, scaling, modification, truncation, and/or deletion of a stream (in conjunction with the SS (164)); (ii) manage a retention policy for a stream that specifies how the lifecycle features are implemented (e.g., requiring periodic truncation (described below)); (iii) manage transactions (e.g., generating transactions (e.g., generating transaction segments), committing transactions (e.g., merging transaction segments), aborting transactions (e.g., dropping a transaction segment), etc.); (iv) be dependent on stateful components (e.g., the consensus service (168), the logger (166) (for the write ahead log functionalities)); (v) manage (and authenticate) metadata requests (e.g., get information about a segment, get information about a stream, etc.) received from Client A (110A) (e.g., manage stream metadata); (vi) be responsible for distribution/assignment of SCs into one or more SSs executing on the streaming storage system (125) (e.g., if a new SS (or a new SS instance) is added to the streaming storage system, the controller may perform a reassignment of SCs along all existing SSs to balance/split the workload); (vii) be responsible for making sense of segments; and/or (viii) manage a control plane of the streaming storage system.

In one or more embodiments, although data streams are typically unbounded, truncating them may be desirable in practical real-world scenarios to manage the amount of storage space the data of a stream utilizes relative to a stream storage system. This may particularly be the case where storage capacity is limited. Another reason for truncating data streams may be regulatory compliance, which may dictate an amount of time an application retains data.

In one or more embodiments, a stream may dynamically change over time and, thus, metadata of that stream may change over time as well. Metadata of a stream may include (or specify), for example (but not limited to): configuration information of a segment, history of a segment (which may grow over time), one or more scopes, transaction metadata, a logical structure of segments that form a stream, etc. The controller (162) may store metadata of streams (which may enable exactly-once semantics) in a table segment, which may include an index (e.g., a B+ tree index) built on segment attributes (e.g., key-value pairs associated to segments). In one or more embodiments, the corresponding “stream metadata” may further include, for example, a size of a data chunk stored in long-term storage (140) and an order of data in that data chunk (for reading purposes and/or for batch analytics purposes at a later point-in-time).

As used herein, a “scope” may be a string and may convey information to a user/administrator for the corresponding stream (e.g., “FactoryMachines”). A scope may act as a namespace for stream identifiers (e.g., as folders do for files) and stream identifiers may be unique within a scope. Further, a stream may be uniquely identified by a combination of its stream identifier and scope. In one or more embodiments, a scope may be used to separate identifiers by tenants (in a multi-tenant environment), by a department of an organization, by a geographic location, and/or any other categorization a user selects.

One of ordinary skill will appreciate that the controller (162) may perform other functionalities without departing from the scope of the invention. When providing its functionalities, the controller may perform all, or a portion, of the methods illustrated in FIGS. 4.1 and 4.2. The controller may be implemented using hardware, software, or any combination thereof.

In one or more embodiments, as being a stateless component, the SS (164) may (further) include functionality to, e.g.: (i) manage the lifecycle of segments (where the SS may be unaware of streams but may store segment data); (ii) generate, merge, truncate, and/or delete segments, and serve read/write requests received from Client A (110A); (iii) use both a durable log (e.g., 166) and long-term storage (140) to store data and/or metadata; (iv) append new data to the durable log synchronously before responding to Client A, and write data asynchronously to the long-term storage (which is the primary destination of data); (v) use its cache to serve tail stream reads, to read ahead from the long-term storage, and/or to avoid reading from the durable log when writing to the long-term storage; (vi) monitor the rate of event traffic in each segment individually to identify trends and based on these trends, associate a trend label (described below) with the corresponding segment; (vii) make sure that each segment maps to only one SC (via a hash function) at any given time, in which that SS instance may maintain metadata (e.g., a rate of traffic into the related segment locally, a scaling type, a target rate, etc.); (viii) in response to a segment being identified as being either hot or cold, the hot/cold segment state is communicated to a central scaling coordinator component of the controller (162) (in which that component consolidates the individual hot/cold states of multiple segments and calculates a centralized auto-scaling decision for a stream such as by replacing hot segments with multiple new segments and/or replacing multiple cold segments with a consolidated new segment); (ix) be dependent on stateful components (e.g., the consensus service (168), the logger (166) (for the write ahead log functionalities)); (x) manage data paths (e.g., a write path, a read path, etc.); (xi) manage (and authenticate) data requests received from Client A; and/or (xii) manage a data plane of the streaming storage (125) (e.g., implement read, write, and other data plane operations).

One of ordinary skill will appreciate that the SS (164) may perform other functionalities without departing from the scope of the invention. When providing its functionalities, the SS may perform all, or a portion, of the methods illustrated in FIGS. 4.1 and 4.2. The SS may be implemented using hardware, software, or any combination thereof.

In one or more embodiments, a trend label may have one of three values, e.g., “normal”, “hot”, or “cold”. A segment identified as “hot” may be characterized by a traffic trend that is greater than a predetermined target rate of traffic. The target rate may be supplied by a user via predetermined a stream policy (e.g., a stream/scaling policy may be defined on a data stream such that if a segment gets more than the required number of events, it may be divided). A segment identified as “cold” may be characterized by a traffic trend that is less than the target traffic rate. For example, a hot segment may be a candidate for scale-up into two or more new segments (e.g., Segment 2 being split into Segment 4 and Segment 5). As yet another example, a cold segment may be a candidate for scale-down via merger with one or more other cold segments (e.g., Segment 4 and Segment 5 being merged into Segment 6). As yet another example, a normal segment may be a candidate for remaining as a single segment.

In one or more embodiments, a consensus service may be required to have/keep a consistent view/state of a current SC distribution/assignment across the streaming storage systems (executing on the system (e.g., 100, FIG. 1.1)). For example, identifiers of SCs and their assignments may need to be consistent across the streaming storage systems and one way to achieve this is implementing the consensus service. To this end, the consensus service (168) (e.g., Apache Zookeeper) may include functionality to, e.g.: (i) perform one or more coordination tasks (e.g., helping to the controller (162) for the assignment/distribution of SCs to SS instances, helping a split of workloads across segments, etc.), and/or (ii) store no stream metadata.

One of ordinary skill will appreciate that the consensus service (168) may perform other functionalities without departing from the scope of the invention. The consensus service may be implemented using hardware, software, or any combination thereof.

In one or more embodiments, SC A (165A) and SC B (165B) may allow users and/or applications to read/access data that was written in SC A and SC B and stored in the long-term storage (140) at the background. In one or more embodiments, SC A and SC B may be useful to perform an active-passive data replication. For example, SC A and SC B are writing data and at the same time, SS A and SS B may serve batch analytics tasks (e.g., batch reads) of data processing applications (of Client A (110A)) (for example, for a better user experience).

Further, the embodiment provided in FIG. 1.2 may utilize the inherent capabilities of the streaming storage system (125) deployed to the infrastructure node (e.g., 120, FIG. 1.1) to move data to the long-term storage (140) jointly with the SCs (e.g., 165A, 165B, etc.) as a form of active-passive data replication, which is useful for various different analytics workloads. For example, a user (of Client A (110A)) may perform real-time analytics on stream data (with the help of the logger (166), where the logger may persist the most recently written stream data) and at the same time, the related SCs (e.g., SC A, SC B, etc.) may move the data progressively to the long-term storage (140) (i) for serving batch reads/analytics at a later point-in-time (for example, upon receiving a batch read request from the user) and (ii) for enabling storage tiering capabilities provided by the streaming storage system (e.g., to perform active-passive data replication).

In one or more embodiments, as being part of the tiered storage streaming system (e.g., tier-2 storage), the long-term storage (140) may provide long-term (e.g., near-infinite retention), durable, high read/write throughput (e.g., to perform batch analytics; to perform generate, read, write, and delete operations; erasure coding; etc.) historical stream data storage/protection with near-infinite scale and low-cost. The long-term storage may be, for example (but not limited to): pluggable storage, AWS S3, Apache HDFS, Dell Isilon, Dell ECS, object storage, block storage, file system storage, etc. In one or more embodiments, the long-term storage may be located/deployed outside of the streaming storage system (125) deployed to the infrastructure node (e.g., 120, FIG. 1.1), in which asynchronous migration of events from tier-1 storage to tier-2 storage (without affecting the performance of tail reads/writes) may reflect different access patterns to stream data.

In one or more embodiments, the long-term storage (140) may be a fully managed cloud (or local) storage that acts as a shared storage/memory resource that is functional to store unstructured and/or structured data. Further, the long-term storage may also occupy a portion of a physical storage/memory device or, alternatively, may span across multiple physical storage/memory devices.

In one or more embodiments, the long-term storage (140) may be implemented using physical devices that provide data storage services (e.g., storing data and providing copies of previously stored data). The devices that provide data storage services may include hardware devices and/or logical devices. For example, the long-term storage may include any quantity and/or combination of memory devices (i.e., volatile storage), long-term storage devices (i.e., persistent storage), other types of hardware devices that may provide short-term and/or long-term data storage services, and/or logical storage devices (e.g., virtual persistent storage/virtual volatile storage).

For example, the long-term storage (140) may include a memory device (e.g., a dual in-line memory device), in which data is stored and from which copies of previously stored data are provided. As yet another example, the long-term storage may include a persistent storage device (e.g., an SSD), in which data is stored and from which copies of previously stored data is provided. As yet another example, the long-term storage may include (i) a memory device in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data).

Further, the long-term storage (140) may also be implemented using logical storage. Logical storage (e.g., virtual disk) may be implemented using one or more physical storage devices whose storage resources (all, or a portion) are allocated for use using a software layer. Thus, logical storage may include both physical storage devices and an entity executing on a processor or another hardware device that allocates storage resources of the physical storage devices.

In one or more embodiments, the long-term storage (140) may store/log/record unstructured and/or structured data that may include (or specify), for example (but not limited to): a valid (e.g., a granted) request and its corresponding details, an invalid (e.g., a rejected) request and its corresponding details, historical stream data and its corresponding details, content of received/intercepted data packets/chunks, information regarding a sender (e.g., a malicious user, a high priority trusted user, a low priority trusted user, etc.) of data, information regarding the size of intercepted data packets, a mapping table that shows the mappings between an incoming request/call/network traffic and an outgoing request/call/network traffic, a cumulative history of user activity records obtained over a prolonged period of time, a cumulative history of network traffic logs obtained over a prolonged period of time, previously received malicious data access requests from an invalid user, a backup history documentation of a workload, a model name of a hardware component, a version of an application, a product identifier of an application, an index of an asset (e.g., a file, a folder, a segment, etc.), recently obtained customer/user information (e.g., records, credentials, etc.) of a user, a cumulative history of initiated model training operations (e.g., sessions) over a prolonged period of time, a restore history documentation of a workload, a documentation that indicates a set of jobs (e.g., a data backup job, a data restore job, etc.) that has been initiated, a documentation that indicates a status of a job (e.g., how many jobs are still active, how many jobs are completed, etc.), a cumulative history of initiated data backup operations over a prolonged period of time, a cumulative history of initiated data restore operations over a prolonged period of time, an identifier of a vendor, a profile of an invalid user, a fraud report for an invalid user, one or more outputs of the processes performed by the controller (162), power consumption of components of the streaming storage system (125), etc. Based on the aforementioned data, for example, the infrastructure node (e.g., 120, FIG. 1.1) may perform user analytics to infer profiles of users communicating with components exist in the streaming storage system.

In one or more embodiments, the unstructured and/or structured data may be updated (automatically) by third-party systems (e.g., platforms, marketplaces, etc.) (provided by vendors) or by administrators based on, for example, newer (e.g., updated) versions of SLAs being available. The unstructured and/or structured data may also be updated when, for example (but not limited to): a data backup operation is initiated, a set of jobs is received, a data restore operation is initiated, an ongoing data backup operation is fully completed, etc.

In one or more embodiments, the long-term storage (140) may provide an indexing service (e.g., a registration service). That is, data may be indexed or otherwise associated with registration records (e.g., a registration record may be a data structure that includes information (e.g., an identifier associated with data) that enables the recorded data to be accessed). More specifically, an agent of the long-term storage may receive various data related inputs directly (or indirectly) from Client A (110A). Upon receiving, the agent may analyze those inputs to generate an index(es) for optimizing the performance of the long-term storage by reducing a required amount of database access(es) when implementing a request (e.g., a data retrieval request). In this manner, requested data may be quickly located and accessed from the long-term storage using an index of the requested data. In one or more embodiments, an index may refer to a database structure that is defined by one or more field expressions. A field expression may be a single field name such as “user_number”. For example, an index (e.g., E41295) may be associated with “user_name” (e.g., Adam Smith) and “user_number” (e.g., 012345), in which the requested data is “Adam Smith 012345”.

In one or more embodiments, the unstructured and/or structured data may be maintained by, for example, the infrastructure node (e.g., 120, FIG. 1.1). The infrastructure node may add, remove, and/or modify those data in the long-term storage (140) to cause the information included in the long-term storage to reflect the latest version of, for example, SLAs. The unstructured and/or structured data available in the long-term storage may be implemented using, for example, lists, tables, unstructured data, structured data, etc. While described as being stored locally, the unstructured and/or structured data may be stored remotely, and may be distributed across any number of devices without departing from the scope of the invention.

While the long-term storage (140) has been illustrated and described as including a limited number and type of data, the long-term storage may store additional, less, and/or different data without departing from the scope of the invention. In the embodiments described above, the long-term storage is demonstrated as a separate entity; however, embodiments herein are not limited as such. In one or more embodiments, the long-term storage may be a part of the cloud.

One of ordinary skill will appreciate that the long-term storage (140) may perform other functionalities without departing from the scope of the invention. When providing its functionalities, the long-term storage may perform all, or a portion, of the methods illustrated in FIGS. 4.1 and 4.2. The long-term storage may be implemented using hardware, software, or any combination thereof.

Turning now to FIG. 2.1, FIG. 2.1 shows how the streaming storage system (e.g., 125, FIG. 1.2) may be utilized as a storage substrate (e.g., may be utilized as an intermediate result storage and transfer layer) for data-intensive serverless functions and data-intensive serverless function (FaaS) pipelining in accordance with one or more embodiments of the invention. The embodiment shown in FIG. 2.1 may show a scenario where a “word count” algorithm/model (that obtains one or more files including words and count the number of words) is built using serverless functions (e.g., Mapper A (270A), Mapper B (270B), Reducer A (271A), Reducer B (271B), etc.) that use one or more data streams (e.g., 272) to transfer intermediate results (of the functions) instead of storing those results in object storage (as inputs for another function to retrieve/read).

One of ordinary skill will appreciate that the presented approach/framework (in FIGS. 2.1-2.3 and 3) may be applied to other scenarios without departing from the scope of the invention. In particular, in FIG. 2, the “word count” scenario is considered due to its clarity. However, the presented framework (e.g., the framework that uses the streaming abstraction instead data objects) can also be considered for large files (with GBs of text) to achieve major performance gains.

As indicated in the scenario, the input dataset (e.g., data input (273)) and the output dataset (e.g., data output (274)) of the whole process may still be stored in the object storage (e.g., a long-term storage (240)), in which all the partial/intermediate results from the calculations (performed by the functions) are written to the data stream (272) (in order to optimize all the intermediate data transfers across the functions). The long-term storage (240) may be an example of the long-term storage discussed above in reference to FIG. 1.2.

As being a first group/stage of functions, Mapper A (270A) and Mapper B (270B) may receive the data input (273) from the long-term storage (240) and read the corresponding parts of the data input (e.g., Mapper A may read “Hello world!” and Mapper B may read “Hello! How are you?”) (or, in another embodiment, Mapper A and Mapper B may read two separate data inputs (e.g., two separate files)). Mapper A and Mapper B may then write their intermediate results (e.g., the number of occurrences of a specific word in the data input) to the data stream (272) such as, for example, Mapper A may write “Hello=1; world=1” and Mapper B may write “Hello=1; How=1; are=1; you=1”. As soon as Mapper A writes “Hello=1”, the next function (e.g., Reducer A (271A)) that is reading from the data stream may immediately receive that (e.g., without waiting for Mapper A to complete its whole process, such as writing “Hello=1; world=1” to the stream).

As being a second group of functions, as soon as an intermediate result(s) are written (by Mapper A and Mapper B) to the data stream (e.g., (a) without waiting for Mapper A and Mapper B to complete their whole computations/processes on the data input and (b) allowing the function pipelining in a stream manner/fashion as soon as the first byte of information is available (in the data stream) to process), Reducer A (271A) and Reducer B (271B) may start processing/reading the corresponding intermediate results from the data stream such that all the same words go to the same reducer function. For example, (i) all the “Hello” words go to Reducer A and (ii) Reducer A may write “Hello=2” to the stream so that the next function (e.g., Reducer C (271C)) that is reading from the data stream may immediately receive that (e.g., without waiting for Reducer A to complete its whole process, such as writing “Hello=2; world=1” to the stream).

Reducer A (271A) and Reducer B (271B) may then write their intermediate results to the data stream (272) such as, for example, Reducer A may write “Hello=2; world=l” and Reducer B may write “How=1; are=1; you=1”. Thereafter, as soon as an intermediate result(s) are written to the data stream (by Reducer A and Reducer B), Reducer C (271C) may start processing/reading the corresponding intermediate results from the data stream (without waiting for Reducer A and Reducer B to complete their whole processes) and combine/merge those “word count” results to generate the data output (274). For example, the data output may specify “Hello=2; world=1; How=1; are=1; you=1”. Reducer C may then store the data output to the long-term storage (240), for example, for later use.

In one or more embodiments, the aforementioned serverless functions (e.g., Mapper A (270A), Mapper B (270B), Reducer A (271A), Reducer B (271B), etc.) and grouping/stating of these functions may be managed/coordinated by a pipeline orchestrator (e.g., 127, FIG. 1.1)/FaaS scheduler of a FaaS platform (that utilizes the functionalities provided by the streaming storage system (e.g., 125, FIG. 1.1)), which is a separate entity from the controller and SS of the streaming storage system. The orchestrator may also repartition the data stream (272) according to the number of serverless functions writing and reading data to/from it, which may help aligning the parallelism of the stream data with the number of serverless functions (e.g., the compute parallelism). The orchestrator may be implemented using hardware, software, or any combination thereof.

As discussed above, the implementation of the streaming storage system (e.g., 125, FIG. 1.2) for pipelining data-intensive serverless functions improves the overall performance of the functions (because there is no need to wait for the previous function to complete and store its result to object storage) so that the functions may feed on results of other functions as soon as the first byte (of a result) is available, rather than waiting for a function to complete its job to ingest its output. Referring to FIG. 2.1, using data streams, instead of objects to store intermediate results, in FaaS pipelines may significantly increase compute parallelism and reduce execution time(s) (e.g., associated with each function). Further, FIG. 2.1 shows the impact of having dependent functions (i.e., mappers and reducers in “word count”) with respect to execution time of being able to process data as soon as it is generated/available by the previous function.

Turning now to FIG. 2.2, FIG. 2.2 shows how using a data stream (of Pravega) (e.g., as an intermediate result storage and transfer layer) instead of object storage may improve a compute parallelism and overall compute time in data-intensive serverless function (FaaS) pipelining in accordance with one or more embodiments of the invention.

Similar to FIG. 2.1, FIG. 2.2 (e.g., the serverless function parallelism (or the compute parallelism) relative to execution time) shows that not having to wait for the previous serverless function to complete and store its result to object storage may provide overall performance improvements in data-intensive FaaS pipelines. Conventionally, object storage may force each function to execute sequentially (where intermediate results are stored to object storage); however, with the stream-like pipelining approach presented in this disclosure (which is enabled via the streaming storage system (e.g., 125, FIG. 1.2)), serverless functions (e.g., Mapper A (270A), Mapper B (270B), Reducer A (271A), Reducer B (271B), etc.) may be pipelined by using streams instead of objects (or object storage) (e.g., the functions execute almost in parallel, which significantly increases compute parallelism and reduce execution time(s) associated with each function).

Turning now to FIG. 2.3, FIG. 2.3 shows how routing keys and the exclusive assignment of segments to readers (or reader components) may be used to generate a map-reduce-like computation framework for FaaS pipelines in accordance with one or more embodiments of the invention. The scenario considered in FIG. 2.1 is also considered in FIG. 2.3, in which a “word count” model is built using serverless functions (e.g., Mapper A (270A), Mapper B (270B), Reducer A (271A), Reducer B (271B), etc.) that use one or more data streams (e.g., Stream A (283), Stream B (284), etc.) to transfer intermediate results (of the functions) instead of storing those results in object storage (as inputs for another function to retrieve/read).

As indicated, FIG. 2.3 shows another advantage of exploiting data streams in data-intensive FaaS pipelines that is leveraging routing keys in event writes for generating a map-reduce-like computation framework. Referring to FIG. 1.2, the streaming storage system (e.g., Pravega) provides total-ordering guarantees on event writes from the same writer to the same routing key. In one or more embodiments, a routing key may be used to write all events (associated with a given routing key) to the same stream segment. Said another way, a routing key on an event may determine in which segment(s) the event should be written and, in this manner, the capacity of the stream may be scaled up.

Referring to FIG. 1.2, the streaming storage system may also guarantee that in an RG, only a single reader may read from a given stream segment at a given point-in-time. With at least these two functionalities, Pravega may partition data in such a way that is potentially exploitable for executing map-reduce-like computations (e.g., via mappers, reducers, etc.) in serverless function pipelines.

In one or more embodiments, Mapper A (270A) may read data (“Hello world!”) from Data Input A (280) and write “Hello=1; world=” to Segment 0 (285) of Stream A (283) events in the form of “{word}=1” tuples (e.g., event=“Hello=1”), in which Stream A (283) includes, at least, Segment 0 and Segment 1 (286). As indicated, the “word” should also be used as a routing key (e.g., routingKey=“Hello”), so that the same word (e.g., “Hello”) (or the same event containing the word “Hello”) from different mappers (e.g., Mapper A and Mapper B (270B)) may land on the same stream segment (e.g., Segment 0). For example, one mapper (e.g., Mapper A) reads the word “Hello” from its input dataset (e.g., Data Input A specifying “Hello world!”) and writes “Hello=1” to Segment 0 of Stream A using the routing key “Hello”. Similarly, a second mapper (e.g., Mapper B) reads the word “Hello” from its input dataset (e.g., Data Input B (281) specifying “Hello! How are you?”) and writes “Hello=” to Segment 0 of Stream A using the routing key “Hello”.

On the other hand, as a result of reading Data Input B (281), Mapper B (270B) may also write (i) “How=1” to Segment 1 (286) of Stream A (283) using the routing key “How”, (ii) “are=1” to Segment 1 of Stream A using the routing key “are”, and (iii) “you=1” to Segment 1 of Stream A using the routing key “you”. Thereafter, given the fact that Segment 0 (285) and Segment 1 (286) can only be acquired by a single reader within an RG (so that there will be no missing events or no duplicates when reading stream data (in the same order written by the writers)), Reducer A (271A) is responsible for Segment 0 (which is a partition of Stream A that will be hosted/owned by a corresponding SC) and Reducer B (271B) is responsible for Segment 1 (which is a partition of Stream A that will be hosted/owned by a corresponding SC).

To this end, (i) Reducer A (271A) may read the two “Hello=1” tuples written by the two mappers (e.g., Mapper A (270A) and Mapper B (270B)) and “world=1” written by Mapper A to Segment 0 (285) of Stream A (283), and (ii) Reducer B (271B) may read “How=1; are=1; you=1” written by Mapper B to Segment 1 (286) of Stream A (where Stream A keeps the intermediate results produced by the mappers), then the reducers may sum up the occurrences of words with the guarantee that all the same occurrences of a given word will be stored on the same segment (e.g., Segment 0 (288) of Stream B (284)), and therefore the sum of these words (e.g., event=“Hello=2”; event=“world=1”; event=“are=1”; event=“How=1”; event=“you=1”; etc.) will represent the global number of occurrences of these words in the original dataset(s) (e.g., 280 and 281).

To complete the overall computation, a final reducer (e.g., Reducer C (271C)) collects the results from all the reducers (e.g., Reducer A (271A) and Reducer B (271B)) and generate an output (e.g., Data Output (274)) in a desired format, for example, to store the output to the long-term storage (e.g., 240, FIG. 2.1).

As indicated above, it is key to set the correct number of stream segments according to the number of parallel serverless functions in use (e.g., correct-sizing of the stream parallelism). This is not only important for the ingestion throughput of a data stream(s), but also important to enable/facilitate the interaction of serverless functions with Pravega (e.g., reading from a stream, writing to the stream, etc.). That is, the number of stream segments lower than the number of readers would mean that there would be serverless functions unable to read data, and therefore, not able to perform any valuable computation. To overcome this issue, the orchestrator (that schedules the functions for execution) takes care of generating the streams (in conjunction with the controller (e.g., 162, FIG. 1.2)) for the pipeline with the correct stream parallelism. That is, before starting any computation, the orchestrator may determine the number of functions to execute (based on (i) a user-defined limit or (ii) the inspection of the input dataset). With this information, the orchestrator (in conjunction with the controller (e.g., 162, FIG. 1.2)) may generate the necessary data streams for the pipeline and set the correct degree of parallelism accordingly.

Turning now to FIG. 3, FIG. 3 shows how stream transactions and checkpoints may be utilized to achieve exactly-once semantics in data-intensive serverless function pipelines in accordance with one or more embodiments of the invention.

In most cases, exactly-once semantics in data-intensive serverless function pipelines need to be achieved such that when a function failure occur, that function may easily be re-triggered to resume its processing. In these cases, it may be desirable to allow the re-triggered function to resume from its last processed data, so the pipeline does not re-process the same data again (which could lead to duplicates). While there are ad-hoc solutions to this issue, utilizing the one or more functionalities of the streaming storage system (e.g., 125, FIG. 1.2) may provide a generic solution to this issue.

The embodiment shown in FIG. 3 may show a scenario where “stream transaction (described above in reference to FIG. 1.2)” and “checkpoint” functionalities of the streaming storage system (e.g., 125, FIG. 1.2) are used to achieve/provide exactly-once semantics in data-intensive serverless function pipelines (e.g., a scenario that shows how transactions along with state synchronization to guarantee that events in pipelines are ingested exactly once).

As used herein, a “checkpoint” may generate a consistent “point-in-time” persistence of each reader in an RG by using a specialized event (e.g., a checkpoint event) to signal each reader to preserve its state. Stream users (e.g., user entities, readers, reader components, etc.) may generate (via a state synchronizer) one or more checkpoints relative to a data stream. A checkpoint may be a named set of offsets for one or more stream events that an application (e.g., a reader, a serverless function, etc.) may use to resume from. One or more checkpoints may be employed by an application to mark a position in a data stream at which to roll back to at a future reading session, in which in the case of stateful applications, such “stream” checkpoints may be coordinated with checkpoints of the application itself.

In one or more embodiments, a checkpoint may be built upon, and thus, may include one or more stream cuts (or manage those stream cuts in a coordinated way), in which (i) a stream cut may mark a position in a data stream (e.g., in a segment) specifying that where each reader is and (ii) in a checkpoint, the stream cut may provide the position information for the data stream. Those skilled in the art will appreciate that a stream cut may be provided separately from a checkpoint as well. In one or more embodiments, one or more stream cuts (e.g., a collection of segments and the corresponding offsets in the segments that may be picked up to resume a process) may be stored in a key-value table (e.g., a Pravega key-value table), in which storing may include, for example, uploading, downloading, posting, writing, generating, and/or the like.

In the key-value table (e.g., an API of Pravega), stream cuts and checkpoints (e.g., checkpoint 0 and its associated data, checkpoint 1 and its associated data, etc.) may be stored based on any suitable ordering, such as being ordered according to time, and may include an identifier that corresponds to (i) a location along a data stream or (ii) a location of multiple segments of a data stream that are written in parallel along a data stream.

In one or more embodiments, a state synchronizer (which is an API provided by the streaming storage system (e.g., 125, FIG. 1.2)) may initiate a checkpoint on an RG, in which once the checkpoint has been completed, the state synchronizer may use the checkpoint to reset all the readers in the RG to the known consistent state represented by the checkpoint. In one or more embodiments, a state synchronizer may, e.g.: (i) be a basis to linearize and make consistent changes on a shared state across different functions with an optimistic concurrency (e.g., the state synchronizer may enable reads and changes (by the corresponding readers/functions) to be made to the shared state with consistency); (ii) provide strong consensus for an RG with respect to replicated state machines (e.g., enabling applications to replicate states), leader election, membership management, transaction management, and/or other distributed computing functionalities; (iii) use a data stream to provide a synchronization mechanism for a state shared between multiple processes running in a cluster; (iv) be used to store data or a map with different key-value pairs in the key-value table; (v) be used to manage a state of an RG and the corresponding readers; (vi) be a component where changes to a shared state may be written through it to a data stream to keep track of all changes to the shared state; and/or (vii) help readers such that the readers may track the states of distributed events (e.g., which segments are assigned to which readers, pending checkpoints, positions of each reader in an RG at the time of a checkpoint, etc.), for example, for consistent workload balancing.

In one or more embodiments, no two concurrent transactions may be allowed to proceed. This may be required to prevent any duplicates because when a reader performs its job, the reader may need to update a state of the synchronizer conditionally before reading and committing/processing.

Turning to the scenario shown in FIG. 3, each group of serverless functions consuming/reading from a data stream is organized as a separate RG, in which instead of writing on a per-event basis, data in the data stream is written as transactions (as a group of multiple events, such as, t0, t1, etc.). For example, (i) “Input Group” may include, at least, Function A1 (302A) and Function N1 (302N) (in which the group receives a data stream that includes multiple segments as inputs (e.g., Function N1 may receive a video file, resize the video file, and write the resized video file to the stream)); (ii) “Reader Group 2” may include, at least, Function A2 (304A) and Function N2 (304N) (in which each function/reader reads from the corresponding segment (e.g., Function N2 may blur off faces in the resized video file and write its intermediate results to the stream)); (iii) “Reader Group M” may include, at least, Function AM (306A) and Function NM (306N) (in which each function reads from the corresponding segment (e.g., Function NM may generate a thumbnail based on the intermediate results of Function N2)); and (iv) “Output Group N” may include, at least, Function AN (308A) and Function NN (308N) (in which the group generates a data output).

As shown in FIG. 3, for each RG, one or more checkpoints may be configured to be triggered periodically (e.g., every 10 seconds) or in demand and in the meantime, serverless functions (e.g., 304A, 304N, 306N, etc.) may consume data from the appropriate stream and write their intermediate/partial results on the corresponding stream transaction. Accordingly, one or more stream cuts may indicate (i) which function is reading from what location in the stream and/or (ii) the locations at where all these functions were reading at a point of a checkpoint.

In one or more embodiments, for example, each function in “Reader Group 2” may coordinate with the state synchronizer to initiate a checkpoint. Based on that, each function may update/store its local state and then each function may flush/write any event that needs to flushed (e.g., when a checkpoint generation is triggered, functions within an RG may flush any remaining event to the corresponding transaction and after the checkpoint is generated, functions may commit their respective transactions). Once this process is completed, each function may notify/update the state synchronizer indicating that each function completed the flushing. Thereafter, the state synchronizer may collectively generate a stream cut (or multiple stream cuts), for example, that represent a function's position at the time the state synchronizer received a “completion” notification from the function. Based on that, if necessary (e.g., in the case of a function failure/crash in between checkpoints), the function may be re-initiate/re-triggered (by the orchestrator (e.g., 127, FIG. 1.1)) and may roll back to the stream cut point and resumes its job/operation (rather than processing form the beginning).

From a different perspective, for example, (i) at a first point-in-time, any remaining events may be flushed to the corresponding transaction, (ii) at a second point-in-time, a checkpoint may be generated, (iii) at a third point-in-time, the corresponding transactions may be committed, (iv) after (i)-(iii) are completed successfully, a stream cut may be generated and stored (along with the associated checkpoint data) in the key-value table (to indicate that until this stream cut, everything was normal), and/or (v) after (i)-(iv) are completed successfully, a new process/cycle may be started. If a function crashes in the middle of the aforementioned cycle (e.g., because the function have not committed the corresponding transactions), the function may roll back to the most recent stream cut point and resumes from there (described below).

In one or more embodiments, checkpoint data may include (or specify), for example (but not limited to): a last known offset in a data stream (e.g., to resume processing), a transaction identifier of a transaction, an identifier of a stream segment assigned to a serverless function, etc.

In one or more embodiments, stream transactions (in Pravega) guarantee that all the events in a transaction are visible to the corresponding readers atomically. For example, (i) eventually, the transaction is aborted due a failure of a function, so none of “event 0, event 1, and event 2” of the transaction are visible to any readers, or (ii) eventually, the transaction is committed successfully, so the readers will be able to read all the events. To this end, the data from the checkpoint and the transaction identifier (TID) (which is managed by the controller (e.g., 162, FIG. 1.2)) per-reader should be persistently stored (in the key-value table) in order to track (in each processing stage of the serverless function pipeline) the last committed group of messages/events and the position of readers when this happened.

In the case of a failure (e.g., if a function crashes in the middle of a transaction, if the function committed to a first transaction but have not committed to a second transaction and then the function fails, etc.), the function (after re-initiated) may retrieve the corresponding information from the key-value table to infer (i) where is the correct position in the stream to resume processing, (ii) the last transaction that was committed by the function before the failure, and/or (iii) up to what offset has been successfully committed (with the help of the function's states (where a “state” may represent a starting file offset+a TID (e.g., {reader-a (Function A1): object/offset-TID})), where the function keeps its states using the state synchronizer).

In the positive case (e.g., if the function fails/crashes after completing the corresponding transaction), a new function (or the re-initiated function) may just need to re-take the segments assigned to the function (related to the failure) and continue processing the transaction (with the help of the state synchronizer). In the negative case (e.g., if the function fails/crashes before completing the corresponding transaction), the corresponding transaction may still be open (e.g., events may have been appended but the transaction is still open). For this reason, a new function (or the re-initiated function) may need to own the transaction again and complete the commit process before resuming its processing (e.g., the new function may read the latest state from the state synchronizer to infer the status of the “failed” transaction based on the corresponding TID to start over).

In one or more embodiments, in both cases, it may be possible to continue processing right from a stream location at which the “previous” function crashed, in which checkpoint information/data may be useful to recover from this crash impacting all the other functions within the related RG. If only a single function crashes, logic of the related RG may re-assign the segments associated with the crashed function to other functions of the relate RG, which may then resume processing from the last known position for that function (e.g., the last checkpoint).

As indicated in FIG. 3, both the input state (e.g., Input Group 1) and the output stage (e.g., Output Group N) differ from the intermediate stages (e.g., Reader Group 2 and Reader Group M). For example, Input Group 1 (the input serverless functions group) may keep track (via the key-value table of Pravega) of the progress of the input (or the input dataset), which may occur outside of Pravega (e.g., the object being read/or its offset). As yet another example, Output Group N (the output serverless functions group) may keep track of the progress of the output (or the output dataset) in the case of a crash. Both stages may be necessary to be able to satisfy exactly-once semantics (in an end-to-end manner), which involves interactions with non-Pravega input/output services.

FIGS. 4.1 and 4.2 show a method for managing a serverless function pipeline in accordance with one or more embodiments of the invention. While various steps in the method are presented and described sequentially, those skilled in the art will appreciate that some or all of the steps may be executed in different orders, may be combined or omitted, and some or all steps may be executed in parallel without departing from the scope of the invention.

Turning now to FIG. 4.1, the method shown in FIG. 4.1 may be executed by, for example, the above-discussed Client A (e.g., 110A, FIG. 1.2), controller (e.g., 162, FIG. 1.2), orchestrator (e.g., 127, FIG. 1.1), serverless functions, and the long-term storage (e.g., 140, FIG. 1.2). Other components of the system (100) illustrated in FIG. 1 may also execute all or part of the method shown in FIG. 4.1 without departing from the scope of the invention.

In Step 400, the orchestrator receives a data processing request from a requesting entity (e.g., a user/customer of Client A, an administrator terminal, a first user that initiated the data processing request, etc.) from Client A, in which the request may include a first data input (e.g., 280, FIG. 2.3) and a second data input (e.g., 281, FIG. 2.3) that are obtained from the long-term storage.

In Step 402, in response to receiving the request, as part of that request, and/or in any other manner (e.g., before initiating any computation/processing in a pipeline), the orchestrator issues/generates/schedules one or more serverless functions (e.g., a first serverless function, a second serverless function, etc.) for execution and for enabling the correct degree of compute parallelism. More specifically, before initiating any computation, the orchestrator may determine the number of functions to execute (based on (i) a user-defined limit or (ii) the inspection of the data inputs). After this determination, the orchestrator may start using a data stream (that is generated by the controller in conjunction with the SS (e.g., 164, FIG. 1.2)) for the pipeline with the correct degree of stream parallelism.

In one or more embodiments, the orchestrator may manage the execution of the serverless functions, without providing a function runtime environment. For example, an implementation of the orchestrator may generate a container image out of a function implementation and execute in a function runtime environment (e.g., a Docker environment).

In Step 404, a first SF of the pipeline reads a first dataset from the first data input. For example, the first SF may read “Hello world!” from the first data input. In Step 406, a second SF of the pipeline reads a first dataset from the second data input. For example, the second SF may read “Hello! How are you?” from the second data input.

In Step 408, after analyzing the first dataset of the first data input, the first SF writes a first intermediate result to a first stream segment of the data stream using a routing key. For example, using “Hello” as the routing key, the first SF may write “Hello=1” in the first stream segment, which indicates the number of “Hello” occurrences in the first dataset of the first data input.

In Step 410, after analyzing the first dataset of the second data input, the second SF writes a second intermediate result to the first stream segment of the data stream using the routing key. For example, using “Hello” as the routing key, the second SF may write “Hello=” in the first stream segment, which indicates the number of “Hello” occurrences in the first dataset of the second data input.

In Step 412, a third SF of the pipeline reads the first intermediate result and second intermediate result from the first stream segment of the data stream. In one or more embodiments, the third SF may be a part of an RG, in which a state synchronizer may have an ability to initiate a checkpoint on the RG. In Step 414, after analyzing/processing the first intermediate result and second intermediate result, the third SF writes/flushes all of its intermediate results (“Hello=2; world=1”) as events to the corresponding stream transaction. Thereafter, the third SF may notify a state synchronizer indicating that the flushing is completed. The state synchronizer may then generate a first checkpoint (including one or more stream cuts) so that the third SF may start committing/processing the transaction.

Turning now to FIG. 4.2, the method shown in FIG. 4.2 may be executed by, for example, the above-discussed orchestrator, serverless functions, and the long-term storage (e.g., 140, FIG. 1.2). Other components of the system (100) illustrated in FIG. 1 may also execute all or part of the method shown in FIG. 4.2 without departing from the scope of the invention.

In Step 416, after the first checkpoint is generated (in Step 414 of FIG. 4.1), the third SF starts committing the stream transaction.

In Step 418, before generating a second checkpoint (e.g., at a second time after the first checkpoint has been generated), the state synchronizer may check whether or not any notification has been received from the third SF to generate the second checkpoint. The state synchronizer may then determine that no notification has been received from the third SF and notify the orchestrator about the issue. Thereafter, upon receiving the notification from the state synchronizer, the orchestrator makes a determination that as to whether the third SF is failed. Accordingly, in one or more embodiments, if the result of the determination is YES, the method proceeds to Step 420. If the result of the determination is NO, the method alternatively proceeds to Step 426.

In Step 420, as a result of the determination in Step 418 being YES, the orchestrator may further determine how the third SF failed. For example, if the third SF failed (e.g., stop processing data) after completing the transaction, the orchestrator may re-initiate the third SF so that the third SF re-takes the segments assigned to it and continue processing the transaction. As yet another example, if the third SF failed while completing the transaction (e.g., if the function failed before completing the transaction), the orchestrator may re-initiate the third SF so that the third SF rolls back to the most recent checkpoint (e.g., the first checkpoint specifying the corresponding stream cut), owns the transaction, completes the commit process, and resumes processing the transaction.

In Step 422, upon finalizing the processing of the transaction (by employing a set of linear, non-linear, and/or ML models), the third SF generates a data output, in which the data output may specify “Hello=2; world=1; How=1; are=1; you=1”. In Step 424, the third SF may then store (in a desired format) the data output to the long-term storage, for example, for later use. Thereafter, the third SF may notify the orchestrator about the completed operation and the generated data output. Based on that, the orchestrator may initiate notification of the user (who sent the data processing request in Step 400 of FIG. 4.1) about the generated data output, in which the notification may be displayed on the GUI of Client A. In one or more embodiments, the method may end following Step 424.

In Step 426, as a result of the determination in Step 418 being NO and upon finalizing the processing of the transaction (by employing a set of linear, non-linear, and/or ML models), the third SF generates a data output, in which the data output may specify “Hello=2; world=1; How=1; are=1; you=1”. In Step 428, the third SF may then store (in a desired format) the data output to the long-term storage, for example, for later use. Thereafter, the third SF may notify the orchestrator about the completed operation and the generated data output. Based on that, the orchestrator may initiate notification of the user (who sent the data processing request in Step 400 of FIG. 4.1) about the generated data output, in which the notification may be displayed on the GUI of Client A. In one or more embodiments, the method may end following Step 428.

Turning now to FIG. 5, FIG. 5 shows a diagram of a computing device in accordance with one or more embodiments of the invention.

In one or more embodiments of the invention, the computing device (500) may include one or more computer processors (502), non-persistent storage (504) (e.g., volatile memory, such as RAM, cache memory), persistent storage (506) (e.g., a non-transitory computer readable medium, a hard disk, an optical drive such as a CD drive or a DVD drive, a Flash memory, etc.), a communication interface (512) (e.g., Bluetooth interface, infrared interface, network interface, optical interface, etc.), an input device(s) (510), an output device(s) (508), and numerous other elements (not shown) and functionalities. Each of these components is described below.

In one or more embodiments, the computer processor(s) (502) may be an integrated circuit for processing instructions. For example, the computer processor(s) (502) may be one or more cores or micro-cores of a processor. The computing device (500) may also include one or more input devices (510), such as a touchscreen, keyboard, mouse, microphone, touchpad, electronic pen, or any other type of input device. Further, the communication interface (512) may include an integrated circuit for connecting the computing device (500) to a network (e.g., a LAN, a WAN, Internet, mobile network, etc.) and/or to another device, such as another computing device.

In one or more embodiments, the computing device (500) may include one or more output devices (508), such as a screen (e.g., a liquid crystal display (LCD), plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing devices exist, and the aforementioned input and output device(s) may take other forms.

The problems discussed throughout this application should be understood as being examples of problems solved by embodiments described herein, and the various embodiments should not be limited to solving the same/similar problems. The disclosed embodiments are broadly applicable to address a range of problems beyond those discussed herein.

One or more embodiments of the invention may be implemented using instructions executed by one or more processors of a computing device. Further, such instructions may correspond to computer readable instructions that are stored on one or more non-transitory computer readable mediums.

While embodiments discussed herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

1. A method for managing a serverless function (SF) pipeline, the method comprising:
receiving, by an orchestrator, a request from a client, wherein, in response to receiving the request, the orchestrator generates a first SF and a second SF;
reading, by the first SF of the pipeline, a dataset from a data input;
writing, by the first SF and after analyzing the dataset, an intermediate result (IR) to a first stream segment (SS) of a data stream using a routing key,
wherein a segment container (SC) hosts the first SS, wherein a segment store manages the SC,
wherein the data stream comprises at least the first SS and a second SS;
reading, by the second SF of the pipeline, the IR from the first SS, wherein the second SF is a part of a reader group;
writing, by the second SF, the IR to a transaction;
starting, by the second SF and after a checkpoint is generated by a state synchronizer, to process the transaction;
making, by the orchestrator, a determination that the second SF is failed, wherein the orchestrator manages the pipeline;
re-initiating, by the orchestrator and based on the determination, the second SF, wherein, upon re-initiated, the second SF resumes processing the transaction from the checkpoint, wherein the checkpoint is shared with the second SF by the state synchronizer via a key-value table;
generating, by the second SF and upon completion of the processing of the transaction, a data output; and
storing, by the second SF, the data output to a tier-2 storage.

2. The method of claim 1,
wherein the data stream is a continuous, unbounded, append-only, and durable sequence of bytes,
wherein the IR specifies an event that is a group of bytes comprising a measurement performed in a client, and
wherein the routing key is a universally unique identifier that allows the first SF to determine that the first SF needs to write the IR to the first SS.

3. The method of claim 2,
wherein a controller of a streaming storage system manages the data stream,
wherein the streaming storage system further comprises the segment store and the SC, and
wherein the SC further hosts the second SS.

4. The method of claim 1,
wherein the orchestrator makes the determination to implement an exactly-once semantics process in conjunction with the controller to durably store the data stream without suffering from a possibility of data duplication and storage overhead on a reconnection after a failure of the second SF, and
wherein, based on the exactly-once semantics process, the second SF obtains a last known offset in the data stream from the checkpoint.

5. The method of claim 4, wherein the checkpoint specifies at least one selected from a group consisting of the last known offset in the data stream to resume processing, a transaction identifier of the transaction, and an identifier of the first SS.

6. The method of claim 5,
wherein the transaction identifier of the transaction is assigned by the controller, wherein the controller of a streaming storage system manages a lifecycle of the transaction, and
wherein the checkpoint is generated by the state synchronizer of the streaming storage system.

7. The method of claim 6, wherein the streaming storage system comprises a tier-1 storage, wherein the tier-1 storage is a distributed write-ahead log providing short-term, durable, and low-latency data protection of the data stream.

8. The method of claim 7, wherein the tier-2 storage is a pluggable object storage providing long-term and durable data protection of the data stream.

9. A non-transitory computer-readable medium comprising computer-readable program code, which when executed by a computer processor enables the computer processor to perform a method for managing a serverless function (SF) pipeline, the method comprising:
receiving, by an orchestrator, a request from a client, wherein, in response to receiving the request, the orchestrator generates a first SF and a second SF;
reading, by the first SF of the pipeline, a dataset from a data input;
writing, by the first SF and after analyzing the dataset, an intermediate result (IR) to a first stream segment (SS) of a data stream using a routing key,
wherein a segment container (SC) hosts the first SS, wherein a segment store manages the SC,
wherein the data stream comprises at least the first SS and a second SS;
reading, by the second SF of the pipeline, the IR from the first SS, wherein the second SF is a part of a reader group;
writing, by the second SF, the IR to a transaction;
starting, by the second SF and after a checkpoint is generated by a state synchronizer, to process the transaction;
making, by the orchestrator, a determination that the second SF is failed, wherein the orchestrator manages the pipeline;
re-initiating, by the orchestrator and based on the determination, the second SF, wherein, upon re-initiated, the second SF resumes processing the transaction from the checkpoint, wherein the checkpoint is shared with the second SF by the state synchronizer via a key-value table;
generating, by the second SF and upon completion of the processing of the transaction, a data output; and
storing, by the second SF, the data output to a tier-2 storage.

10. The non-transitory computer-readable medium of claim 9,
wherein the data stream is a continuous, unbounded, append-only, and durable sequence of bytes,
wherein the IR specifies an event that is a group of bytes comprising a measurement performed in a client, and
wherein the routing key is a universally unique identifier that allows the first SF to determine that the first SF needs to write the IR to the first SS.

11. The non-transitory computer-readable medium of claim 10,
wherein a controller of a streaming storage system manages the data stream,
wherein the streaming storage system further comprises the segment store and the SC, and
wherein the SC further hosts the second SS.

12. The non-transitory computer-readable medium of claim 9,
wherein the orchestrator makes the determination to implement an exactly-once semantics process in conjunction with the controller to durably store the data stream without suffering from a possibility of data duplication and storage overhead on a reconnection after a failure of the second SF, and
wherein, based on the exactly-once semantics process, the second SF obtains a last known offset in the data stream from the checkpoint.

13. The non-transitory computer-readable medium of claim 12, wherein the checkpoint specifies at least one selected from a group consisting of the last known offset in the data stream to resume processing, a transaction identifier of the transaction, and an identifier of the first SS.

14. The non-transitory computer-readable medium of claim 13,
wherein the transaction identifier of the transaction is assigned by the controller, wherein the controller of a streaming storage system manages a lifecycle of the transaction, and
wherein the checkpoint is generated by the state synchronizer of the streaming storage system.

15. The non-transitory computer-readable medium of claim 14, wherein the streaming storage system comprises a tier-1 storage, wherein the tier-1 storage is a distributed write-ahead log providing short-term, durable, and low-latency data protection of the data stream.

16. The non-transitory computer-readable medium of claim 15, wherein the tier-2 storage is a pluggable object storage providing long-term and durable data protection of the data stream.

17. A system for managing stream data, the system comprising:
a processor comprising circuitry;
memory comprising instructions, which when executed perform a method, the method comprising:
receiving, by an orchestrator, a request from a client, wherein, in response to receiving the request, the orchestrator generates a first SF and a second SF;
reading, by the first SF of the pipeline, a dataset from a data input;
writing, by the first SF and after analyzing the dataset, an intermediate result (IR) to a first stream segment (SS) of a data stream using a routing key,
wherein a segment container (SC) hosts the first SS, wherein a segment store manages the SC,
wherein the data stream comprises at least the first SS and a second SS;
reading, by the second SF of the pipeline, the IR from the first SS, wherein the second SF is a part of a reader group;
writing, by the second SF, the IR to a transaction;
starting, by the second SF and after a checkpoint is generated by a state synchronizer, to process the transaction;
making, by the orchestrator, a determination that the second SF is failed, wherein the orchestrator manages the pipeline;
re-initiating, by the orchestrator and based on the determination, the second SF, wherein, upon re-initiated, the second SF resumes processing the transaction from the checkpoint, wherein the checkpoint is shared with the second SF by the state synchronizer via a key-value table;
generating, by the second SF and upon completion of the processing of the transaction, a data output; and
storing, by the second SF, the data output to a tier-2 storage.

18. The system of claim 17,
wherein the data stream is a continuous, unbounded, append-only, and durable sequence of bytes,
wherein the IR specifies an event that is a group of bytes comprising a measurement performed in a client, and
wherein the routing key is a universally unique identifier that allows the first SF to determine that the first SF needs to write the IR to the first SS.

19. The system of claim 18,
wherein a controller of a streaming storage system manages the data stream,
wherein the streaming storage system further comprises the segment store and the SC, and
wherein the SC further hosts the second SS.

20. The system of claim 17,
wherein the orchestrator makes the determination to implement an exactly-once semantics process in conjunction with the controller to durably store the data stream without suffering from a possibility of data duplication and storage overhead on a reconnection after a failure of the second SF, and
wherein, based on the exactly-once semantics process, the second SF obtains a last known offset in the data stream from the checkpoint.
